(19) United States
(12) Patent Application Publication
(10) Pub. No.: US 2025/0240673 A1
(43) Pub. Date: Jul. 24, 2025

(54) TECHNIQUES FOR ULTRA-WIDEBAND (UWB)-BASED SIDELINK COMMUNICATIONS

(71) Applicant: QUALCOMM Incorporated, San Diego, CA (US)

(72) Inventors: Tom BARAK, Rehovot (IL); Michael LEVITSKY, Rehovot (IL); Daniel PAZ, Atlit (IL); Alexander SVERDLOV, Rehovot (IL)

(21) Appl. No.: 18/419,416

(22) Filed: Jan. 22, 2024

(51) Int. Cl. H04W 28/20; H04L 5/00; H04W 16/14; H04W 28/08; H04W 72/40

(52) U.S. Cl. CPC H04W 28/20; H04L 5/001; H04W 16/14; H04W 28/0967; H04W 72/40

(57) ABSTRACT

Methods, systems, and devices for wireless communications are described. A user equipment (UE) may establish a wireless connection with a wireless communications device via an unlicensed wireless communications channel. The UE may transmit control signaling to the wireless communications device. The control signaling may include a communications configuration that indicates one or more constraints for communicating within the unlicensed wireless communications channel. In some examples, the constraints may include a minimum bandwidth of the unlicensed wireless communications channel, a Fourier transform constraint, a subcarrier spacing (SCS) constraint, or a combination thereof. The UE may communicate one or more sidelink messages with the wireless communications device via the unlicensed wireless communications channel using a set of communications parameters based on the communications configuration and including a component carrier bandwidth, a fast Fourier transform (FFT) size, and an SCS.

### FIELD OF TECHNOLOGY

The following relates to wireless communications, including techniques for ultra-wideband (UWB)-based sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Extended reality (XR) applications, including virtual reality (VR) and augmented reality (AR) applications, continue to be an exciting extension of wireless technology. However, with XR devices, there is a tension between the need for high data rates to support XR applications, and the desire to keep XR devices relatively small (e.g., for extended use and user comfort) with improved battery life.

### SUMMARY

The described techniques relate to improved methods, systems, devices, and apparatuses that support techniques for ultra-wideband (UWB)-based sidelink communications. For example, the described techniques provide for rules or configurations that define specific sets of wireless communications parameters (e.g., bandwidth, subcarrier spacing (SCS), fast Fourier transform (FFT) size) that may be used, for example, between an extended reality (XR) device and a user equipment (UE). In particular, specific sets of wireless communications parameters as described herein may be used for communications between the XR device and the UE depending on applicable constraints and restrictions placed on a UWB channel. For example, the UWB channel may be subject to one or more various constraints that may be defined by the network, the Federal Communications Commission (FCC), or both, such as a minimum bandwidth requirement, allowable SCSs, and a minimum valid FFT size. Such constraints may be strictly applied in some cases, and may be relaxed in other cases. The application or relaxation of such constraints may be pre-configured at the UE, and/or signaled to the UE by the network, where the UE may indicate the applicable constraints (and/or relaxation of such constraints) to the XR device. Based on the one or more constraints applicable to the wireless channel, the UE and the XR device may be configured to apply defined sets of wireless communications parameters.

A method by a UE is described. The method may include establishing a wireless connection with a wireless communications device via an unlicensed wireless communications channel, transmitting control signaling to the wireless communications device, the control signaling including a communications configuration that indicates one or more constraints for communicating within the unlicensed wireless communication channel, the one or more constraints including a minimum bandwidth of the unlicensed wireless communications channel, a Fourier transform constraint, an SCS constraint, or any combination thereof, and communicating one or more sidelink messages with the wireless communications device via the unlicensed wireless communications channel using a set of communications parameters determined based on the communications configuration, where the set of communications parameters include a component carrier bandwidth, an FFT size, and an SCS.

A UE is described. The UE may include one or more memories storing processor executable code, and one or more processors coupled with the one or more memories. The one or more processors may individually or collectively be operable to execute the code to cause the UE to establish a wireless connection with a wireless communications device via an unlicensed wireless communications channel, transmit control signaling to the wireless communications device, the control signaling including a communications configuration that indicates one or more constraints for communicating within the unlicensed wireless communication channel, the one or more constraints including a minimum bandwidth of the unlicensed wireless communications channel, a Fourier transform constraint, an SCS constraint, or any combination thereof, and communicate one or more sidelink messages with the wireless communications device via the unlicensed wireless communications channel using a set of communications parameters determined based on the communications configuration, where the set of communications parameters include a component carrier bandwidth, an FFT size, and an SCS.

Another UE is described. The UE may include means for establishing a wireless connection with a wireless communications device via an unlicensed wireless communications channel, means for transmitting control signaling to the wireless communications device, the control signaling including a communications configuration that indicates one or more constraints for communicating within the unlicensed wireless communication channel, the one or more constraints including a minimum bandwidth of the unlicensed wireless communications channel, a Fourier transform constraint, an SCS constraint, or any combination thereof, and means for communicating one or more sidelink messages with the wireless communications device via the unlicensed wireless communications channel using a set of communications parameters determined based on the communications configuration, where the set of communications parameters include a component carrier bandwidth, an FFT size, and an SCS.

A non-transitory computer-readable medium storing code is described. The code may include instructions executable by one or more processors to establish a wireless connection with a wireless communications device via an unlicensed wireless communications channel, transmit control signaling to the wireless communications device, the control signaling including a communications configuration that indicates one or more constraints for communicating within the unlicensed wireless communication channel, the one or more constraints including a minimum bandwidth of the unlicensed wireless communications channel, a Fourier transform constraint, an SCS constraint, or any combination thereof, and communicate one or more sidelink messages with the wireless communications device via the unlicensed wireless communications channel using a set of communications parameters determined based on the communications configuration, where the set of communications parameters include a component carrier bandwidth, an FFT size, and an SCS.

Some examples of the method, UEs, and non-transitory computer-readable medium described herein may further include operations, features, means, or instructions for receiving, from a network entity, radio resource control signaling indicating an SCS numerology associated with one or more SCSs for communicating with the network entity and communicating one or more messages with the network entity in accordance with the one or more SCSs associated with the SCS numerology, where the SCS constraint associated with communications over the unlicensed wireless communication channel includes an expansion of the SCS numerology to include one or more additional SCSs within the SCS numerology, and where the SCS used to communicate the one or more sidelink messages with the wireless communications device may be different from the one or more SCSs based on the expansion of the SCS numerology.

In some examples of the method, UEs, and non-transitory computer-readable medium described herein, the minimum bandwidth includes a 500 MHz minimum bandwidth constraint, the Fourier transform constraint includes an 8 k FFT size constraint, and the SCS constraint includes an expansion of an SCS numerology to include one or more additional SCSs and the component carrier bandwidth includes 500 MHz, the FFT size includes 8192, and the SCS includes 62.5 kHz.

In some examples of the method, UEs, and non-transitory computer-readable medium described herein, the minimum bandwidth includes a 500 MHz minimum bandwidth constraint, the Fourier transform constraint includes an 4 k FFT size constraint, and the SCS constraint includes an expansion of an SCS numerology to include one or more additional SCSs and the component carrier bandwidth includes 500 MHz, the FFT size includes 4096, and the SCS includes 125 KHz.

In some examples of the method, UEs, and non-transitory computer-readable medium described herein, the minimum bandwidth includes a 500 MHz minimum bandwidth constraint, the Fourier transform constraint includes an 8 k FFT size constraint, and the SCS constraint includes an expansion of an SCS numerology to include one or more additional SCSs and the component carrier bandwidth includes 1000 MHz, the FFT size includes 8192, and the SCS includes 125 kHz.

In some examples of the method, UEs, and non-transitory computer-readable medium described herein, the minimum bandwidth includes a 500 MHz bandwidth constraint, the Fourier transform constraint includes an 8 k FFT size constraint, and the SCS constraint includes an SCS of 60 kHz or 120 kHz and the component carrier bandwidth includes 983 MHz, the FFT size includes 8192, and the SCS includes 120 KHz.

In some examples of the method, UEs, and non-transitory computer-readable medium described herein, the Fourier transform constraint further includes a radix 2 or radix 4 FFT constraint.

Some examples of the method, UEs, and non-transitory computer-readable medium described herein may further include operations, features, means, or instructions for communicating one or more messages with a network entity in accordance with one or more radix FFT sizes, where the Fourier transform constraint includes a composite radix size constraint, and where the FFT size for communicating the one or more sidelink messages with the wireless communications device may be different from the one or more FFT sizes based on the composite radix size constraint.

In some examples of the method, UEs, and non-transitory computer-readable medium described herein, the one or more radix FFT sizes include Radix 2, Radix 3, Radix 5, or any combination thereof and the FFT size for communicating the one or more sidelink messages with the wireless communications device may be determined based on the composite radix size constraint and in accordance with a Cooley Tukey algorithm, or a prime factor algorithm, or both.

In some examples of the method, UEs, and non-transitory computer-readable medium described herein, the minimum bandwidth includes a 500 MHz minimum bandwidth constraint, the Fourier transform constraint includes an 8 k FFT size constraint and a composite radix size constraint, and the SCS constraint includes a preservation of SCS numerology and the component carrier bandwidth includes 500 MHz, the FFT size includes 8640, and the SCS includes 60 kHz.

In some examples of the method, UEs, and non-transitory computer-readable medium described herein, the minimum bandwidth includes a 500 MHz minimum bandwidth constraint, the Fourier transform constraint includes an 8 k FFT size constraint and a composite radix size constraint, and the SCS constraint includes a preservation of an SCS numerology to maintain a minimum quantity of usable SCSs within the SCS numerology and the component carrier bandwidth includes 500 MHZ, the FFT size includes 4320, and the SCS includes 120 KHz.

In some examples of the method, UEs, and non-transitory computer-readable medium described herein, the minimum bandwidth includes a 500 MHz minimum bandwidth constraint, the Fourier transform constraint includes an 8 k FFT size constraint and a composite radix size constraint, and the SCS constraint includes a preservation of an SCS numerology to maintain a minimum quantity of usable SCSs within the SCS numerology and the component carrier bandwidth includes 1000 MHZ, the FFT size includes 8640, and the SCS includes 120 KHz.

In some examples of the method, UEs, and non-transitory computer-readable medium described herein, the minimum bandwidth includes a relaxation of a 500 MHZ minimum bandwidth constraint, the Fourier transform constraint includes an 8 k FFT size constraint, and the SCS constraint includes a preservation of an SCS numerology to maintain a minimum quantity of usable SCSs within the SCS numerology and the component carrier bandwidth includes 491 MHz, the FFT size includes 8192, and the SCS includes 60 kHz.

In some examples of the method, UEs, and non-transitory computer-readable medium described herein, the minimum bandwidth includes a relaxation of a 500 MHZ minimum bandwidth constraint, the Fourier transform constraint includes an 8 k FFT size constraint, and the SCS constraint includes a preservation of an SCS numerology to maintain a minimum quantity of usable SCSs within the SCS numerology and the component carrier bandwidth includes 491 MHz, the FFT size includes 4096, and the SCS includes 120 kHz.

In some examples of the method, UEs, and non-transitory computer-readable medium described herein, the minimum bandwidth includes a relaxation of a 1000 MHz minimum bandwidth constraint, the Fourier transform constraint includes an 8 k FFT size constraint, and the SCS constraint includes a preservation of an SCS numerology to maintain a minimum quantity of usable SCSs within the SCS numerology and the component carrier bandwidth includes 983 MHz, the FFT size includes 8192, and the SCS includes 120 kHz.

Some examples of the method, UEs, and non-transitory computer-readable medium described herein may further include operations, features, means, or instructions for performing measurements for the unlicensed wireless communications channel and identifying, based on the measurements, a set of multiple wireless communications devices including the wireless communications device that may be to perform wireless communications multiplexed via the unlicensed wireless communications channel, where the one or more sidelink messages communicated with the wireless communications device may be multiplexed with additional sidelink messages communicated with the set of multiple wireless communications devices in accordance with a frequency-domain multiplexing pattern, a time-domain multiplexing pattern, or both, based on a quantity of wireless communications devices included within the set of multiple wireless communications devices, an emission regulation, or both.

In some examples of the method, UEs, and non-transitory computer-readable medium described herein, a transmit power used to communicate the one or more sidelink messages may be based on the emission regulation and whether the one or more sidelink messages may be communicated in accordance with the frequency-domain multiplexing pattern, the time-domain multiplexing pattern, or both.

Some examples of the method, UEs, and non-transitory computer-readable medium described herein may further include operations, features, means, or instructions for receiving, from a network entity, radio resource control signaling indicating the one or more constraints for communicating within the unlicensed wireless communications channel, where transmitting the control signaling, communicating the one or more sidelink messages, or both, may be based on receiving the radio resource control signaling.

Some examples of the method, UEs, and non-transitory computer-readable medium described herein may further include operations, features, means, or instructions for performing measurements for communications performed with the wireless communications device via the unlicensed channel based on establishing the wireless channel with the wireless communications device, where the set of communications parameters may be determined based on the measurements.

In some examples of the method, UEs, and non-transitory computer-readable medium described herein, communicating the one or more sidelink messages may include operations, features, means, or instructions for transmitting the one or more sidelink messages via a set of multiple carriers of the unlicensed wireless communications channel using a transmit power that satisfies the transmit power constraint.

In some examples of the method, UEs, and non-transitory computer-readable medium described herein, the one or more constraints further include a transmit power constraint associated with communications transmitted via the wireless communications channel over a time interval, the one or more sidelink messages may be multiplexed via time-division multiplexing configuration with additional communications performed by a set of multiple additional wireless communications devices throughout the time interval, and a transmit power used to communicate the one or more sidelink messages may be based on the transmit power constraint and the time-division multiplexing configuration.

### BRIEF DESCRIPTION OF THE DRAWINGS

FIG. 1 shows an example of a wireless communications system that supports techniques for ultra-wideband (UWB)-based sidelink communications in accordance with one or more aspects of the present disclosure.

FIG. 2 shows an example of a wireless communications system that supports techniques for UWB-based sidelink communications in accordance with one or more aspects of the present disclosure.

FIGS. 3A and 3B show examples of resource diagrams that support techniques for UWB-based sidelink communications in accordance with one or more aspects of the present disclosure.

FIG. 4 shows an example of a process flow that supports techniques for UWB-based sidelink communications in accordance with one or more aspects of the present disclosure.

FIGS. 5 and 6 show block diagrams of devices that support techniques for UWB-based sidelink communications in accordance with one or more aspects of the present disclosure.

FIG. 7 shows a block diagram of a communications manager that supports techniques for UWB-based sidelink communications in accordance with one or more aspects of the present disclosure.

FIG. 8 shows a diagram of a system including a device that supports techniques for UWB-based sidelink communications in accordance with one or more aspects of the present disclosure.

FIGS. 9 and 10 show flowcharts illustrating methods that support techniques for UWB-based sidelink communications in accordance with one or more aspects of the present disclosure.

### DETAILED DESCRIPTION

Among other examples, extended reality (XR) applications, including virtual reality (VR) and augmented reality (AR) applications, continue to be an extension of wireless technology. The XR applications may require high processing and high data rates to support the XR applications, and may include head-mounted devices (HMDs) and other wearable devices that are intended to be worn for long periods of time to enable the user to move around and interact within the XR environment. As such, there are competing needs to enable XR devices to exhibit high processing capabilities (e.g., to support high data rates), while also keeping the XR devices relatively small and compact to be comfortable to be worn for long durations. Further, most XR devices are wireless devices, as such there is a desire to reduce power consumption and therefore improve battery life of the XR devices, among other advantages.

Ultra-wideband (UWB) communications are one possibility for supporting short range, low power, and low-complexity sidelink communications between XR devices and corresponding user devices (e.g., user equipments (UEs)). However, UWB communications must comply with applicable regulations and restrictions, such as Federal Communications Commission (FCC) regulations and restrictions, for example constraints related to minimum signal bandwidth and effective isotropic radiated power (EIRP). Such constraints or regulations may impact which wireless communications parameters (e.g., bandwidth, SCS (SCS), fast Fourier transform (FFT) size) are able to be used for wireless communications between the XR device and a UE. As such, depending on the applicable constraints and regulations, it may be unclear which one or more wireless communications parameters should be used for communications between the devices.

Accordingly, aspects of the present disclosure are directed to signaling and rules or configurations that define specific sets (e.g., one or more) of wireless communications parameters (e.g., bandwidth, SCS, FFT size) that are to be used between an XR device and a UE. In particular, specific sets of wireless communications parameters as described herein may be used for communications between the XR device and the UE depending on the applicable constraints and restrictions placed on a UWB channel. For example, a UWB channel may be subject to various constraints that may be defined by the network or another source, such as the FCC, (or both), such as a minimum bandwidth requirement, allowable SCSs, and a minimum valid FFT size. Such constraints may be strictly applied in some cases, and may be relaxed in other cases. The application or relaxation of such constraints may be pre-configured at the UE, and/or signaled to the UE by the network, where the UE may indicate the applicable constraints (e.g., and/or relaxation of such constraints) to the XR device. Based on the constraints applicable to the wireless channel, the UE and the XR device may be configured to apply pre-defined sets of wireless communications parameters.

For instance, in cases where the wireless channel exhibits an 8 k minimum valid FFT size, a standard SCS numerology, and a 500 MHz minimum bandwidth requirement, the UE and the XR device may be configured to communicate using an FFT size of 8192, an SCS of 120 kHz, and a bandwidth of 500 MHz. Comparatively, in cases where the wireless channel exhibits an 8 k minimum valid FFT size, an expanded/modified SCS numerology, and a 500 MHz minimum bandwidth requirements, the UE and the XR device may be configured to communicate using an FFT size of 8192, an SCS of 62.5 kHz, and a bandwidth of 500 MHz.

Aspects of the disclosure are initially described in the context of wireless communications systems. Additional aspects of the disclosure are described in the context of example resource configuration and an example process flow. Aspects of the disclosure are further illustrated by and described with reference to apparatus diagrams, system diagrams, and flowcharts that relate to techniques for UWB-based sidelink communications.

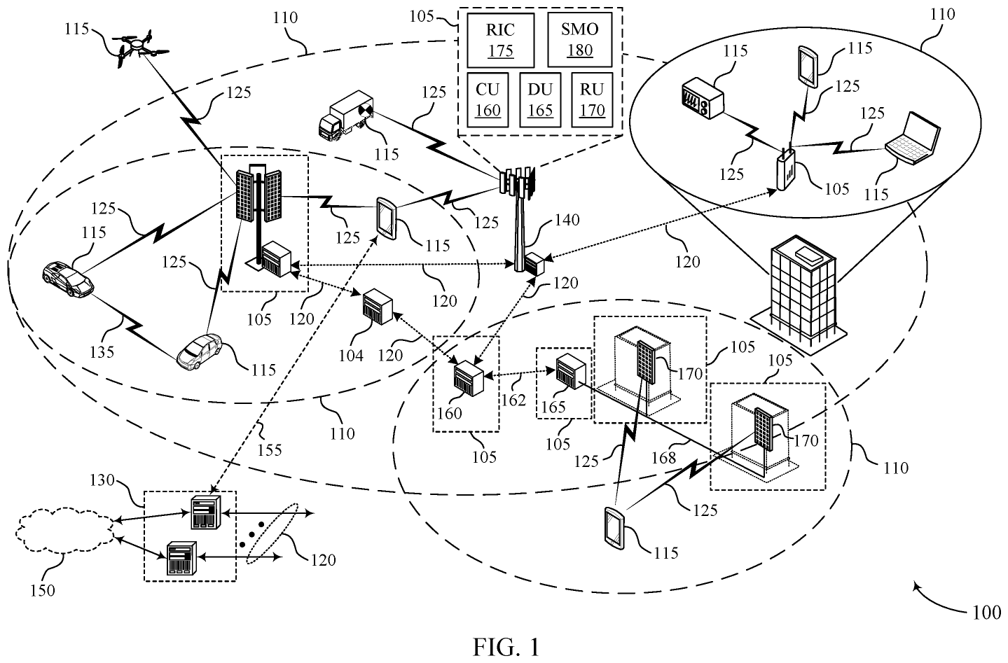

FIG. 1 shows an example of a wireless communications system 100 that supports techniques for UWB-based sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for UWB-based sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include an SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless devices of the wireless communications system 100 may be configured to support specific rules or configurations that define specific sets of wireless communications parameters (e.g., bandwidth, SCS, FFT size) that may be used between a UE 115 and an XR device of the wireless communications system 100 (e.g., HMD, etc.). In particular, specific sets of wireless communications parameters as described herein that may be used for communications between an XR device and a UE 115 depending on the applicable constraints (e.g., restrictions) placed on a UWB channel.

For example, a UWB channel may be subject to various constraints that may be defined by the network or the FCC, such as a minimum bandwidth requirement, allowable SCSs, and a minimum valid FFT size. Such constraints may be strictly applied in some cases, or relaxed in other cases. The application and relaxation of such constraints may be pre-configured at the UE 115, and/or signaled to the UE 115 by the wireless communications system 100 (e.g., the network), where the UE 115 may indicate the applicable constraints (e.g., and/or relaxation of such constraints) to the XR device. Based on the constraints applicable to the wireless channel, the UE 115 and the XR device may be configured to apply pre-defined sets of wireless communications parameters.

For instance, in cases where the wireless channel exhibits an 8 k minimum valid FFT size, a standard SCS numerology, and a 500 MHz minimum bandwidth requirements, the UE 115 and the XR device may be configured to communicate using an FFT size of 8192, an SCS of 120 kHz, and a bandwidth of 500 MHz. Comparatively, in cases where the wireless channel exhibits an 8 k minimum valid FFT size, an expanded/modified SCS numerology, and a 500 MHz minimum bandwidth requirements, the UE 115 and the XR device may be configured to communicate using an FFT size of 8192, an SCS of 62.5 kHz, and a bandwidth of 500 MHz.

Techniques of the present disclosure may enable the use of pre-defined sets of parameters (e.g., bandwidth, SCS, FFT size) by UEs 115 and XR devices. Techniques described herein may improve coordination between the UEs 115 and the XR devices with respect to which parameters should be used for wireless communications, thereby resolving any ambiguities caused by applicable constraints (or relaxation of such constraints). Such pre-defined sets of parameters may enable high bandwidth communications between a UE 115 and an XR device while reducing the processing required at the XR device. As such, techniques described herein may enable the reduction of XR device size, leading to more comfortable user fit and experience. Additionally, by reducing the processing performed at the XR device, the battery life of the XR device may be improved.

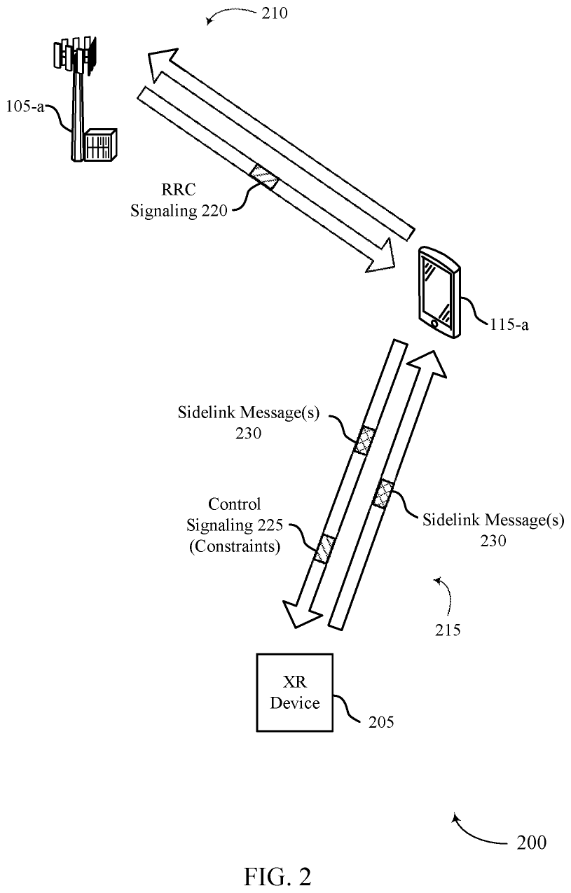

FIG. 2 shows an example of a wireless communications system 200 that supports techniques for UWB-based sidelink communications in accordance with one or more aspects of the present disclosure. Aspects of the wireless communications system 200 may implement, or be implemented by, aspects of the wireless communications system 100. For example, the wireless communications system 200 illustrates signaling and configurations that enable the utilization of pre-defined wireless communications parameters for communications between XR devices and UEs 115 depending on the applicable constraints and restrictions (and/or relaxation of such constraints) placed on an associated UWB channel.

The wireless communications system 200 may include an XR device 205, a UE 115-a, and a network entity 105-a, which may be examples of UEs 115, network entities 105, and other wireless devices as described with reference to FIG. 1. In some aspects, the UE 115-a may communicate with the network entity 105-a via a communication link 210. In some cases, the communication link 210 may include an example of an access link (e.g., Uu link). The communication link 210 may include a bi-directional link that can include both uplink and downlink communications. For example, the UE 115-a may transmit uplink transmissions, such as uplink control signals or uplink data signals, to the network entity 105-a using the communication link 210, and the network entity 105-a may transmit downlink transmissions, such as downlink control signals or downlink data signals, to the UE 115-a using the communication link 210.

Similarly, the UE 115-a and the XR device 205 may communicate via a communication link 215. In some aspects, the communication link 215 may include a UWB-based sidelink or other PC5 link. For example, UE 115-a may transmit communications to the XR device 205 via the communication link 215, and XR device 205 may transmit communications to the UE 115-a via the communication link 215. The UE 115-a may thus wirelessly communicate with the network entity 105-a via the communication link 210 and with the XR device 205 via the communication link 215.

XR applications continue to be an exciting an promising extension of wireless technology, and have the potential to be one of the leading products in personal electronics segment in the next decade. However, there are still many challenges and unsolved limiting issues related to XR applications. Some the biggest issues facing XR applications is the need/desire to make XR devices (e.g., XR device 205) light weight and comfortable for long-term and “on-the-go” use. Additionally, XR devices 205 may be associated with limited processing complexity and power consumption to comply with the available heat dissipation ability on the XR device 205 (e.g., glasses, goggles, etc.). The heat dissipation ability of XR devices such as glasses/goggles may be amplified due to the small form factor and limited surface area of the glasses/goggles as compared to UEs 115 which are generally larger, as heat dissipation ability is proportional to the surface size of the respective device. For smart XR wearable goggles (e.g., XR devices 205), the power consumption limit from the point of view of heat dissipation may be limited to only few Watts. Another important issue facing XR devices 205 is the need to reduce the power consumption of the devices to allow light weight battery and a reasonable battery lifetime.

Taken together, the issues facing XR devices 205 are extremely challenging due to the heavy processing that is required to support many XR applications. Standalone XR devices 205 and products may not be able to comply with the above “on-the-go” requirements, and may be relevant only for some specific use cases, such as static applications with and short time usage scenarios which allow the XR devices 205 to assume a higher form factor HMD (head mounted device) usage.

For most XR applications/scenarios, large form factor XR devices 205 may not be convenient. In such cases, to reduce the complexity, battery size, and processing requirements, part of the XR-related processing may be shifted to a companion device (e.g., UE 115) with a split XR approach. A typical split XR approach may move most of the rendering-related processing to a companion device (e.g., UE 115). However, even with split XR approaches, many processing components are still left on XR device 205 for different E2E considerations (e.g., photon-to-motion latency requirement, XR-to-companion device wireless link capacity, communication link power consumption for long range links, etc.).

While such split XR approaches may significantly reduce power consumption on XR device 205, the power consumption may still be too high, even for a less demanding video quality/user experience benchmark. As such, conventional split XR approaches may not completely solve the issues facing XR applications described above, and may not support more demanding (e.g., premium) XR applications (e.g., XR applications with frames per second≥120 Hz, video formats≥8 k, etc.).

In one case of XR splitting, the XR device 205 may communicate, and offload processes, with the companion device (e.g., such as a network entity 105-a) via long range communications links over a licensed spectrum, where such communications may have tight scheduling thresholds (due to the latency requirements of XR applications) and be staggered among different XR users. However, due to the long range communication links and increased processing of XR applications, a capacity per user of the wireless communications system 200 may be a limitation of such systems.

To mitigate such limitations, the XR device 205 may process data from one or more sensors locally (e.g., at the XR device 205) in order to reduce the uplink data volume, such as data from sensors for six degrees of freedom (6DOF) tracking, data from sensors for eye tracking for field of view (FOV) derivation, or the like. Additionally, to support the limited link capacity for long range communication links, the XR device 205 and the companion device may compress various data packets. For example, the XR device 205 may compress sensor data or camera data from the XR application, while the companion device may compress the rendered video for XR device 205, where such compressions may be performed by both devices with an increased compression factor due to a limited link capacity per user.

However, in such cases, the XR device 205 may experience increased processing and power consumption due to compressing the data. For example, the XR device 205 may pre-process the sensor data in addition to performing video compression with an increased compression factor (e.g., such as a high profile of H264 coding format) in order to support the limited capacity per user of the wireless channel. Such operations, however, may cause complex computations and processing at the XR device 205 (e.g., the encoder side) and may lead the XR device 205 to implement double data rate (DDR) memory usage for both transmission and reception path video processing, where the usage of such DDR memory may increase power consumption at the XR device 205.

Further, due to photon-to-motion latency requirements and latency caused by using a companion device (e.g., network entity 105-a) for XR splitting or offloading, the XR device 205 may also perform asynchronous time wrapping (ATW) for image alignment with the latest pose information, thereby further increasing complexity and processing at the XR device 205. By supporting such compression and processing operations for long range communication links with the companion device (e.g., network entity 105), the power consumption of the XR device 205 (e.g., for light weight small form factor XR wearable smart glasses) may surpass a power consumption threshold (e.g., ˜1.5-3 Watt).

Alternatively, to reduce the effects of such compression and processing techniques, the XR device 205 may communicate with a companion device, such as the UE 115-a, which may enable processing offloading and tethering with a relatively close (physical proximity) companion device or enable processing offloading between the XR device 205 and the UE 115-a and a network entity 105-a. For example, the XR device 205 may communicate with the UE 115-a, where a distance between the UE 115-a the XR device 205 is within a threshold distance (e.g., within close proximity). In such examples, the XR device 205 may transmit various uplink messages using a Wi-Fi D protocol, while the XR device 205 may communicate the downlink message via the communication link 215 using 5G sidelink protocols. Further, the UE 115-a may communicate with the network entity 105-a via 5G NR Uu interfaces (e.g., the communication link 210), where the network entity 105-a may communicate with one or more edge or application servers.

In this way, the XR device 205 may communicate data, or offload processes, with a companion device that is physically located within a threshold distance from the XR device 205. As such, from the perspective of the XR device 205, the split in processing of various XR applications between the XR device 205 and the UE 115-a may assume a similar processing load and locally covered functionality at the XR device 205, but with a local short range communication link with the UE 115-a (e.g., via the communication link 215), which may reduce modem related power consumption. That is, by enabling the XR device 205 to offload data processing with the UE 115-a, the XR device 205 may experience reduced processing and reduced power consumption related to data compression and pre-processing at the modem of the XR device 205.

Further, the XR device 205 may implement techniques for improvements for XR characteristics, key performance indicators (KPIs), or both in order to allow the XR device 205 to be a low power and light weight solution for wearable XR products. For example, such techniques may provide for the XR device 205 to implement increased processing offloading (e.g., aggressive offloading) to the UE 115-a (e.g., or to the network entity 105-a), such that the XR device 205 may be converted, or reduced, to an I/O device that provides (e.g., shares) local sensor information to the UE 115-a without any pre-processing. As an illustrative example of such increased processing offloading, the XR device 205 may transmit sensor data (e.g., camera data) to the UE 115-a, where in response, the XR device 205 may receive a rendered video to be displayed at the XR device 205 without any post-processing. Such increased processing offloading may reduce XR device power consumption (by approximately 50%) relative to current XR splitting XR approaches.

As described, by employing the increased XR functionality split (e.g., aggressive XR functionality split), the XR device 205 may function similar to an I/O device, such that the transmissions and reception complexity of the XR device 205 may be shifted, or moved, to the UE 115-a. Such offloading, or shifting, of transmission and reception complexity from the XR device 205 to the UE 115-a may be desired across all functional components of the XR device 205, including PHY and modem-related complexity. For example, the XR device 205 may experience increased modem complexity due to reception side processing. In order to reduce such complexity, the XR device 205 may implement various techniques, or approaches, for different physical reception components, which may result in a XR sidelink design with low complexity, low power, and low latency.

One such technique may be transmission pre-equalization. For example, the UE 115-a may apply various pre-equalization transmission schemes, which may reduce the receiving complexity and power consumption at the XR device 205. By applying pre-equalization on the UE 115-a and shifting the complexity of the XR device 205 (e.g., equalization complexity, channel estimation and synchronization loops measurements, maintenance related complexity, DFE and FFT and IFFT functionality complexity) to the UE 115-a, the receiver complexity and power consumption of the XR device 205 may be decreased. Additionally, the UE 115-a applying various pre-equalization transmission schemes may allow the same throughput and performance as when the XR device 205 performs the same operations, but without significant degradations and with a performance gain for higher SNRs.

The use of a UWB-based communication link (e.g., the communication link 215) for short range, low power, low complexity and low latency communication channel between the XR device 205 and the UE 115-a may support the high data rates that may be required to support the proposed aggressive XR functionality split (e.g., multiple sensors raw data sharing with the companion device) and associated XR applications in general. However, transmissions over the communication link 215 may be required to comply with various regulations and restrictions (e.g., FCC regulations) for UWB-based communications related to EIRP and minimal signal bandwidth. For example, in some cases the communication link 215 may be associated with the following constraints, limits, or restrictions:
Constraint/Limit #1: EIRP restriction of EIRP_{avg} at 1 ms=−41 dBM at 1 MHz.
Constraint/Limit #2: EIRP restriction of EIRPₚₑₐₖ=0 dBM at 50 MHz.
Constraint/Limit #3: Minimum BW restriction of BW≥500 MHz.

In some cases, UWB EIRP regulations may be associated with transmission-equalization as discussed herein. In some cases, a minimum BW restriction may be considered for UWB, since this definition was defined for native UWB standards which are based on a low time duration pulse transmissions (IR UWB). However, formally anything that is classified as UWB may be required to comply with this minimum BW and other UWB standards (e.g., 802.15.3a) may also follow this requirement. In some examples, UWB BW restrictions may be one of the factors that impact DFE complexity-related considerations and key waveform parameters selection such as numerology and SCS, FFT length and CA options. Different considerations related to these parameters (e.g., corresponding to minimum BW FCC restriction, low complexity DFE target/motivation for XR device, E2E XR sidelink performance aspects and other system considerations) may be addressed herein to explain the proposed set of applicable options and parameters (e.g., values for SCS and numerology, FFT size, CA options) for a low complexity, low latency, and low power UWB based XR sidelink.

Taken together, the XR device 205 may utilize an XR application which may require high processing and high data rates to support the XR application. Additionally, the XR device 205 may be worn by a user for long periods of time while the user moves around and interacts within the XR environment. For example, the XR device 205 may include a HMD that is configured to be worn by a user for AR/VR games or applications. As such, there may be competing needs to enable the XR device 205 to exhibit high processing capabilities (e.g., to support high data rates), while also keeping the XR device 205 relatively small and compact to be comfortable to be worn for long durations. Further, in the case that the XR device 205 may be a wireless device, there may be a desire to reduce power consumption and therefore improve battery life of the XR device 205.

UWB communications may be one possibility for supporting short range, low power, and low-complexity sidelink communications between the XR device 205 and the UE 115-a. However, UWB communications must comply with applicable FCC regulations and restrictions, such as constraints related to minimum signal bandwidth and EIRP. Such constraints or regulations may impact which wireless communications parameters (e.g., BW, SCS, FFT size) are able to be used for wireless communications between the XR device 205 and the UE 115-a. As such, depending on the applicable constraints and regulations, it may be unclear what wireless communications parameters should be used for communications between the XR device 205 and the UE 115-a.

Accordingly, aspects of the present disclosure are directed to specific rules or configurations that define specific sets of wireless communications parameters (e.g., bandwidth, SCS, FFT size) that are to be used between the XR device 205 and the UE 115-a. In particular, specific sets of wireless communications parameters as described herein may be used for communications between the XR device 205 and the UE 115-a depending on the applicable constraints and restrictions placed on a UWB channel (e.g., the communication link 215). For example, the communication link 215 may be subject to various constraints that may be defined by the network or the FCC (e.g., or both), such as a minimum BW requirement, allowable SCSs, and a minimum valid FFT size. Such constraints may be strictly applied in some cases, and may be relaxed in other cases. The application or relaxation of such constraints may be pre-configured at the UE 115-a, signaled to the UE 115-a by the network entity 105-a, or a combination thereof, where the UE 115-a may indicate the applicable constraints (e.g., and/or relaxation of such constraints) to the XR device 205. Based on the constraints applicable to the wireless channel, the UE 115-a and the XR device 205 may be configured to apply pre-defined sets of wireless communications parameters.

For example, the UE 115-a may receive RRC signaling 220 from the network entity 105-a. The RRC signaling 220 may include various communication parameters and applicable constraints for communications via the communication link 215 (e.g., the unlicensed wireless communications channel, the UWB channel), the communication link 210, or both. For instance, the RRC signaling 220 may indicate an SCS numerology that may be associated with one or more SCSs for communicating with the network entity 105-a. In some examples, the UE 115-a may also communicate other messages with the network entity 105-a. For example, the UE 115-a may communicate one or more messages with the network entity 105-a according to the one or more SCSs associated with the SCS numerology, according to one or more radix FFT sizes, or a combination thereof.

The UE 115-a may establish a connection with the XR device 205. For example, the UE 115-a may establish a wireless connection with the XR device 205 via the communication link 215 (e.g., UWB-based sidelink channel).

The UE 115-a and the XR device 205 may communicate according to a high SCS due to one or more benefits. For example, communicating according to a high SCS may enable use of a low time slot, which may be less sensitive to channel aging and synchronization loop drifts associated with equalization-based waveforms of the UE 115-a (e.g., XR device 205 equalization/filtering may not be utilized). Thus, CSI and associated equalization matrix refresh periods may include a higher quantity of slots due to equalized transmission of the UE 115-a utilizing a fixed equalization matrix. Additionally, use of a high SCS may allow for use of lower FFT sizes under applicable UWB restrictions (e.g., for a minimum BW signal of 0.5 GHZ, which may result in lower XR complexity and decreased power consumption. Further, in the case that multiple XR devices 205 may utilize the communication link 215, the use of a high SCS may enable a reduction in channel access latency for the multiple XR devices 205 due to a denser TDM assigned resources grid for a specific pair of UE 115 and XR device 205.

In some examples, the use of a high SCS value may negatively impact end-to-end (E2E) link performance for high frequency channels (e.g., such as are associated with UWB channels), but may allow for an FFT size that may be consistent with BW constraint dependencies associated with the communication link 215. For example, the use of lower SCS, such as 15 KHz or 30 KHz (e.g., that may be used for Sub6 or other low-band communications), may result in a high E2E performance which may be beneficial to sidelink communications, but may require an FFT size of 32 k or 16 k size respectively for a minimum BW signal of 0.5 GHZ (e.g., as may be required for UWB channel communications). While high E2E performance may be desirable, such a high minimum FFT size may be not consistent with the low complexity, low power requirement (e.g., constraint) for sidelink communications and the low SCS spacing options may also result in a significantly higher latency (e.g., due to channel TD access granularity or slot duration). In order to efficiently communicate via the communication link 215, it may be beneficial to balance E2E performance with various constraints for the communication link 215, such as a minimum BW requirement, allowable SCSs, and a minimum valid FFT size.

To determine various communication parameters associated with efficient communication according to various channel constraints, the UE 115-a may perform one or more measurements of the communication link 215. For example, in response to establishing the connection with the XR device 205, the UE 115-a may perform one or more measurements for communications with the XR device 205 via the communication link 215. Additionally, or alternatively, the UE 115 may monitor a network of sidelink channels (including the communication link 215) to perform measurements and monitor for other devices using the respective sidelink channels. The UE 115-a may determine one or more constraints to utilize in efficiently communicating with the XR device 205 via the communication link 215, such as a signal BW of 500 MHz, an SCS candidate of 60 kHz or 120 kHz (e.g., because an SCS of 15 kHz or 30 kHz may correspond to FFT sizes that may be too large, as described herein), an associated FFT size, and an associated numerology. For example, a numerology (μ) of 3 and an SCS of 120 kHz may be determined to be a best tradeoff between performance, complexity, power consumption, and latency for communications via the communication link 215.

In some examples, the UE 115-a may also identify one or more other wireless communications devices on the communication link 215. For example, in response to performing the one or more measurements of the communication link 215, the UE 115-a may identify one or more other XR devices 205 and/or UEs 115 that may perform wireless communications multiplexed via the communication link 215.

In response to performing the one or more measurements of the communication link 215, the UE 115-a may transmit control signaling 225 (e.g., constraints) to the XR device 205. The control signaling 225 may include a communications configuration that indicates the determined constraints or parameters for communicating within the communication link 215. For example, the one or more constraints indicated by the communications configuration of the control signaling may include a minimum BW of the communication link 215, an FFT constraint, an SCS constraint, a transmit power constraint associated with communications transmitted via the unlicensed channel over a time interval, or any combination thereof. The UE 115-a may transmit the control signaling 225 to the XR device 205 based on receiving the RRC signaling 220 from the network entity 105-a.

The UE 115-a may communicate with the XR device 205. For example, in response to receiving the RRC signaling 220 and communicating the control signaling 225, the UE 115-a may communicate one or more sidelink messages 230 with the XR device 205 via the communication link 215 using a set of communications parameters determined based on the communications configuration indicating the constraints (e.g., the control signaling 225) and based on the measurements of the communication link 215. The set of communications parameters may include a component carrier BW, an FFT size, an SCS, or a combination thereof.

In some examples, the set of communications parameters may be based on various restrictions and criteria associated with the communication link 215, such as no minimum BW requirement (e.g., 500 MHZ), a radix 2 or 4 FFT size (e.g., for lower complexity FFT), a maximum 8 k FFT size limitation for reasonable FFT complexity bound, with preserved numerology and SCS options (e.g., according to 5G NR). With these criteria to abide by, the UE 115-a may transmit an SCS of 120 kHz as a valid option for the communication link 215. Additionally, the UE 115-a may communicate a radix-2 FFT size parameter of 8192, as a lower FFT size may not be associated with a minimum BW of 500 MHz at an SCS of 120 kHz. Further, the associated CC BW option may be 500 MHz, since a higher BW (e.g., 1 GHZ) may require a larger FFT size (e.g., 16k FFT).

For example, one or more constraints transmitted by the UE 115-a may include a BW constraint of 500 MHz minimum BW (e.g., 500 MHz may be a minimum signal allocation or minimum component carrier (CC) BW for the communication link 215), the FFT constraint may include a 8 k FFT size constraint (e.g., an 8 k FFT size may be the maximum valid FFT size that may be considered), and the SCS constraint may include an SCS of 60 kHz or 120 kHz, which may result in the communication parameters utilized in the sidelink message communication between the UE 115-a and the XR device 205 including a CC BW of 983 MHZ, an FFT size of 8192, and an SCS of 120 kHz. Additionally, the FFT constraint may also include a radix 2 or radix 4 FFT constraint.

For example, to comply with a targeted BW of 500 MHZ, the UE 115-a may determine the required minimum FFT size to be defined as

$${N}_{FFT} = ⌈ \frac{500 MHz}{S C {S}_{μ} kHz} ⌉ .$$

In the case that the FFT constraint may also include a radix 2 or radix 4 FFT type that may be limited to

$${N}_{FFT} = {2}^{n} = {2}^{⌈ lo {g}_{2} ( \frac{500 MHz}{S C {S}_{μ} kHz} ) ⌉} ,$$

the UE 115-a may determine FFT output BW options as described in Table 1:

TABLE 1
First Implementation Parameters (No relaxation of FCC
min BW Requirement, radix 2/4 FFT sizes, maximum 8k
FFT size, 5G/NR numerology SCS options preserved)

| | | | Min. BW |
|---|---|---|---|
| | | BW | requirement/CC |
| μ (SCS_{μ}) | N_{FFT} = 2ⁿ | (MHz) | BW (MHz) |
| μ = 2, (SCS₂ = 60 kHz) | 4096 (n = 12) | 245.769 | 500 |
| μ = 2, (SCS₂ = 60 kHz) | 8192 (n = 13) | 491.520 | 500 |
| μ = 3, (SCS₃ = 120 kHz) | 4096 (n = 12) | 491.520 | 500 |
| μ = 3, (SCS₃ = 120 kHz) | 8192 (n = 13) | 983.040 | 500 |

The UE 115-a may determine that not all of the determined options (as outlined in Table 1 above) may align with the targeted CC BW (e.g., minimum BW constraint) of 500 MHz, however. For example, the UE 115-a may determine that the communication parameters including a CC BW of 983 MHZ, an FFT size of 8192, and an SCS of 120 kHz (e.g., as depicted in the last entry of Table 1) may comply with the minimum BW requirement of 500 MHz. However, this output (e.g., the last entry of Table 1) may be calculated utilizing a 8 k FFT size, which may be approximately 2 times higher (e.g., factor 2 zero padding/excess computation) than what may be utilized if the minimum BW requirement for the communication link 215 were relaxed to something that may be aligned with BW options corresponding to numerologies used in current techniques (e.g., 5G NR numerologies) and associated N_{FFT} sizes. Thus, utilization of numerologies associated with current technologies (e.g., 5G NR SCS options of μ=2 or μ=3) along with a radix 2 or a radix 4 FFT size option may be inefficient, according to the calculations of the UE 115-a.

In some examples, the UE 115-a may be able to avoid various current regulations and constraints by utilizing the communication link 215. For example, UWB channels (e.g., the communication link 215) may not be required to follow significant frequency division (FD) guards (e.g., as in the case of 5G NR) or may determine that various guards may not be required at all due to various reasons. For example, because UWB channels (e.g., the communication link 215) may not include out-of-bounds (OOB) or in-bounds (IB) leakage regulations, OOB-related requirements associated with the UE 115-a may be relatively relaxed. Additionally, a UWB channel link budget may not allow targeting high signal-to-noise ratio (SNR) (e.g., SNR>˜20 dB) so there may be less sensitivity to IB emissions in the communication link 215. In some examples, the communication link 215 may be associated with relatively high FFT sizes, which may result in relatively lower orthogonal frequency division multiplexing (OFDM) sidelobes. Additionally, with the utilization of UWB channels (e.g., the communication link 215), droop related to decision feedback equalizers (DFE) (e.g., receiver DFE, transmitter DFE) may be accounted for naturally via Tx equalization. In some examples, the set of communications parameters may be based on criteria of no FCC minimum BW requirement (e.g., 500 MHZ), a radix 2 or 4 FFT size (e.g., for lower complexity FFT), a maximum 8 k FFT size limitation for reasonable FFT complexity bound, with modified numerology and SCS options (e.g., modified from 5G NR options). For example, in a second implementation, due to the use of the communication link 215 and the associated relaxations of various regulations, the UE 115-a may expand the SCS numerology utilized in communications via the communication link 215. For example, the SCS constraint associated with communications over the communication link 215 and indicated by the control signaling 225 may include an expansion of the SCS numerology associated with the communication link 210 to include one or more additional SCSs that may be better aligned with communicating via the communication link 215. As such, the SCS used in communications between the UE 115-a and the XR device 205 via the communication link 215 may be different from the one or more SCS utilized in communications via the communication link 210 based on the expansion of the SCS numerology.

The UE 115-a may calculate parameters for communication via the communication link 215, including the expanded SCS numerology. For example, the UE 115-a may determine the SCS options according to N·SCS=1 MHz, where N is an integer. For example, with an N of 8 or 16, the UE 115-a may calculate an SCS of 125 kHz and 62.5 kHz, respectively, which may be associated with numerologies of μ=2 and 3 (e.g., 5G NR numerologies). This calculation may be in compliance with various constraints (e.g., minimum BW constraints, EIRP related constraints) for the communication link 215, as well as other UWB channels, as described in Table 2:

TABLE 2
Second Implementation Parameters (No relaxation of FCC
min BW Requirement, radix 2/4 FFT sizes, maximum 8k
FFT size, 5G/NR numerology SCS options modified)

| | | FFT BW | Targeted CC BW |
|---|---|---|---|
| SCS | N_{FFT} = 2ⁿ | (MHz) | (MHz) |
| SCS = 62.5 kHz | 8192 (n = 13) | 512 | 500 |
| SCS = 125 kHz | 4096 (n = 12) | 512 | 500 |
| SCS = 125 kHz | 8192 (n = 13) | 1024 | 1000 |

For example, one or more constraints transmitted by the UE 115-a may include a BW constraint of 500 MHz minimum BW, the FFT constraint may include an 8 k FFT size constraint, and the SCS constraint may include an expansion of an SCS numerology to include one or more additional SCSs, which may result in the communication parameters utilized in the sidelink message communication including a CC BW of 500 MHz, an FFT size of 8192, and an SCS of 62.5 kHz (e.g., as described in entry 1 of Table 2). In other examples, the communication parameters utilized in the sidelink message communication may include a CC BW of 1000 MHz, an FFT size of 8192, and an SCS of 125 kHz (e.g., as described in entry 3 of Table 2).

In another example, one or more constraints transmitted by the UE 115-a may include a BW constraint of 500 MHz minimum BW, the FFT constraint may include a 4 k FFT size constraint, and the SCS constraint may include an expansion of an SCS numerology to include one or more additional SCSs, which may result in the communication parameters utilized in the sidelink message communication including a component carrier BW of 500 MHZ, an FFT size of 4096, and an SCS of 125 kHz (e.g., as described in entry 2 of Table 2).

In a third implementation, in the case of no FCC minimum BW requirement (e.g., 500 MHZ), the UE 115-a may include a composite radix size constraint associated with the FFT constraint for communications via the communication link 215. The FFT size for communicating with the XR device 205 (e.g., via the communication link 215) may be different from the one or more radix FFT sizes used for communications via the communication link 210 based on the composite radix size constraint. For example, the one or more radix FFT sizes used for communications between the network entity 105-a and the UE 115-a via the communication link 210 may include Radix 2, Radix 3, Radix 5, while the FFT size used by the UE 115-a in communicating one or more sidelink messages with the XR device 205 via the communication link 215 may be based on the composite radix size as defined by N_{FFT}=2^{m}3^{p}5^{q} or according to a Cooley Tukey algorithm, or a prime factor algorithm, or both.

The UE 115-a may calculate parameters for communication via the communication link 215, including the composite radix size constraint associated with the FFT constraint. A composite radix FFT of N_{FFT}=2^{m}3^{p}5^{q}, as may be used for discrete Fourier transform (DFT) size in case of discrete Fourier transform spread orthogonal frequency division multiplexing (DFT-S-OFDM) waveforms for NR, may be required to comply with the minimum BW requirement (e.g., FCC requirement) with a reasonable size FFT that may not include a significant zero padding or guard REs insertion leading to over computation. In some examples, a composite radix FFT may require a higher computation complexity in general from one side of the communication link, but allows a more flexible FFT size selection from the other side the communication link to keep the associated BW closer to the minimum BW requirement. This may result in a better complexity trade off in relation to radix 2 or to radix 4 FFT restrictions. In some examples, the composite radix FFT may allow sizes of N_{FFT}=2^{m}3^{p}5^{q}=N₁·N₂·N₃ that may be evaluated based on a combination of Cooley Tukey algorithms and prime factor algorithms (PFAs). PFA may be applicable for any case of N₁, N₂, N₃ that are co-prime and may allow for evaluation of a single dimensional FFT of size N=N₁·N₂·N₃ via recursive decomposition into smaller FFTs that can be calculation using Radix-2, Radix-3 and Radix-5 based algorithms. This implementation may enable use of numerology options that may be inefficient when used in combination with non-composite radix FFT sizes (e.g., an SCS of 60 kHz, an SCS of 120 kHz), as described in Table 3:

TABLE 3
Third Implementation Parameters (No relaxation of FCC
min BW Requirement, composite radix FFT sizes, maximum
8k FFT size, 5G/NR numerology SCS options preserved)

| | | FFT BW | Targeted CC |
|---|---|---|---|
| SCS | N_{FFT} = 2^{m}3^{p}5^{q} | (MHz) | BW (MHz) |
| SCS = 60 kHz | 8640 (m = 6, p = 3, q = 1) | 518.4 | 500 |
| SCS = 120 kHz | 4320 (m = 5, p = 3, q = 1) | 518.4 | 500 |
| SCS = 120 kHz | 8640 (m = 6, p = 3, q = 1) | 1,036.8 | 1000 |

For example, one or more constraints transmitted by the UE 115-a may include a BW constraint of 500 MHz minimum BW, the FFT constraint may include a 8 k FFT size constraint and a composite radix size constraint, and the SCS constraint may include a preservation of SCS numerology, which may result in the communication parameters utilized in the sidelink message communication including a component carrier BW of 500 MHz, an FFT size of 8640, and an SCS of 60 kHz (e.g., as described in entry 1 of Table 3).

In another example, one or more constraints transmitted by the UE 115-a may include a BW constraint of 500 MHz minimum BW, the FFT constraint may include a 8 k FFT size constraint and a composite radix size constraint, and the SCS constraint may include a preservation of an SCS numerology to maintain a minimum quantity of usable SCSs within the SCSs numerology, which may result in the communication parameters utilized in the sidelink message communication including a component carrier BW of 500 MHz, an FFT size of 4320, and an SCS of 120 kHz (e.g., as described in entry 2 of Table 3). In other examples, the communication parameters utilized in the sidelink message communication may include a component carrier BW of 1000 MHz, an FFT size of 8640, and an SCS of 120 kHz (e.g., as described in entry 3 of Table 3). In some examples, an FFT of 2160 (e.g., m=4, p=3, q=1) may be a valid DFT option (e.g., according to 5G NR specifications), as well as an FFT size that may be a factor 2 multiplication of this length.

In a fourth implementation, the UE 115-a may utilize a relaxed BW constraint in communications via the communication link 215. For example, the FCC minimum BW requirement may be slightly relaxed (e.g., a BW of ˜490 MHz) to better fit 5G NR numerologies and to enable better communication parameter combinations, as described in Table 4. By taking into account a relaxed minimum BW constraint, the UE 115-a may allow for better alignment with various regulations associated with SCS and SCS numerology (e.g., an SCS of 60 kHz or 120 kHz may be utilized in the case that an 8 k FFT size is also utilized, as well as reference timelines for the communication link 215. The use of a relaxed BW constraint, such as a CC BW of ˜491.520 MHz or ˜983.040 MHz, may also allow for use of radix 2 and radix 4 FFT sizes, which may include lower complexity relative to composite radix FFT.

TABLE 4
Fourth Implementation Parameters (Relaxation of FCC min
BW Requirement [~490 MHz], radix 2/4 FFT sizes,
maximum 8k FFT size, 5G/NR numerology SCS options preserved)

| | | | Min. BW |
|---|---|---|---|
| | | BW | requirement/CC |
| μ (SCS_{μ}) | N_{FFT} = 2ⁿ | (MHz) | BW (MHz) |
| μ = 2, (SCS₂ = 60 kHz) | 8192 (n = 13) | 491.520 | 500 |
| μ = 3, (SCS₃ = 120 kHz) | 4096 (n = 12) | 491.520 | 500 |
| μ = 3, (SCS₃ = 120 kHz) | 8192 (n = 13) | 983.040 | 1000 |

For example, one or more constraints transmitted by the UE 115-a may include a BW relaxation constraint of 500 MHz minimum BW, the FFT constraint may include a 8 k FFT size constraint, and the SCS constraint may include a preservation of an SCS numerology to maintain a minimum quantity of usable SCSs within the SCSs numerology, which may result in the communication parameters utilized in the sidelink message communication including a component carrier BW of 491 MHz, an FFT size of 8192, and an SCS of 60 kHz (e.g., as described in entry 1 of Table 4). In other examples, the communication parameters utilized in the sidelink message communication may include a component carrier BW of 491 MHz, an FFT size of 4096, and an SCS of 120 kHz (e.g., as described in entry 2 of Table 4).

In another example, one or more constraints transmitted by the UE 115-a may include a BW relaxation constraint of 1000 MHz minimum BW, the FFT constraint may include a 8 k FFT size constraint, and the SCS constraint may include a preservation of an SCS numerology to maintain a minimum quantity of usable SCSs within the SCS numerology, which may result in the communication parameters utilized in the sidelink message communication including a component carrier BW of 983 MHz, an FFT size of 8192, and an SCS of 120 kHz (e.g., as described in entry 3 of Table 4).

In some cases, the XR device 205 may require a high bit-rate, low complexity, low power usage, and low latency communication link between the XR device 205 and the UE 115-a. For example, the XR device 205 may include multiple XR sensors that may share in UL communications with the UE 115-a which may minimize processing by the XR device 205 but may utilize a high bit-rate link. Additionally, or alternatively, the XR device 205 may utilize a low complexity compression (e.g., with low compression factors) to reduce video encoding related complexity and power consumption (e.g., in cases of short-range links with low transmission power), which may also increase the minimum UL bit-rate requirement. In some other examples, the XR device 205 may be associated with a split architecture in which high resolution and high frames-pre-second (FPS) rendered video may be returned to the XR device 205 via DL communications (e.g., in cases when channel estimation and equalization related complexity may be moved to the UE 115-a), which may also require a high bit-rate.

A UWB channel (e.g., the communication link 215) may be utilized to address any high bit-rate UL or DL requirements of the XR device 205. For example, to satisfy UL and DL bitrate requirements (e.g., and EIRP constraints of EIRP_{avg.at 1 ms}=−41 dBmW at 1 MHz), a high-signal BW (e.g., a BW greater than 0.5 GHz) should be used for communications via the communication link 215. Utilization of a higher BW may allow the UE 115-a (e.g., a transmitter) a lower duty-cycle (e.g., a duty cycle greater than a 1 ms duration) while preserving the same target link throughput. In some examples, a lower duty cycle may enable an increase in transmission power without violation of various constraints (e.g., FCC requirements), which may further improve link range (e.g., or SNR per link) between the XR device 205 and the UE 115-a.

In some examples, use of a high-signal BW may result in the need to address carrier aggregation (CA) options for the communication link 215. For example, one or more carrier aggregation (CA) options may be utilized in communications via the communication link 215 such that a targeted signal BW for the communication link 215 and an associated power consumption may be maintained. Tables 5 and 6 depict power consumption comparisons for various total signal BWs and various CA scenarios (e.g., a quantity of CCs (N_{CC})) with different associated CC BW and FFT sizes (e.g., according to N_{FFT}=2ⁿ) for two (2) SCS numerologies (e.g., Table 5 depicts scenarios associated with an SCS numerology of μ=3 and an SCS option of SCS=120 kHz, and Table 6 depicts scenarios associated with an SCS numerology of μ=2 and an SCS option of SCS=60 kHz). The power consumption data of Tables 5 and 6 may include DFE and FFT-related power consumption for each CA case and, in some examples, the data may correspond to a scenario including two receiver antennas, a high SNR, and an activation duty cycle of 25%.

TABLE 5
Complexity and Power Consumption Tradeoff (μ = 3, SCS = 120 KHz)

| | N_{FFT} =1024 | | N_{FFT} = 2048 | | N_{FFT} = 4096 | | N_{FFT} = 8192 | |
|---|---|---|---|---|---|---|---|---|
| | (CC BW ≈ | | (CC BW ≈ | | (CC BW ≈ | | (CC BW ≈ | |
| | 100 MHz) | | 250 MHz) | | 500 MHz) | | 1000 MHz) | |
| Signal | Power | | Power | | Power | | Power | |
| BW | Consumption | | Consump. | | Consump. | | Consump. | |
| (MHz) | (mW) | N_{CC} | (mW) | N_{CC} | (mW) | N_{CC} | (mW) | N_{CC} |
| 500 | 21.28 | 5 | 15.99 | 2 | 14.96 | 1 | | |
| 1000 | 35.11 | 10 | 27.3 | 4 | 22.47 | 2 | 14.92 | 1 |
| 2000 | 65.09 | 20 | 47.16 | 8 | 41.18 | 4 | 29.84 | 2 |

TABLE 6
Complexity and Power Consumption Tradeoff (μ = 2, SCS = 60 KHz)

| | N_{FFT} = 1024 | | N_{FFT} = 2048 | | N_{FFT} = 4096 | | N_{FFT} = 8192 | |
|---|---|---|---|---|---|---|---|---|
| | (CC BW ≈ | | (CC BW ≈ | | (CC BW ≈ | | (CC BW ≈ | |
| | 50 MHz) | | 120 MHz) | | 250 MHz) | | 500 MHz) | |
| Signal | Power | | Power | | Power | | Power | |
| BW | Consumption | | Consump. | | Consump. | | Consump. | |
| (MHz) | (mW) | N_{CC} | (mW) | N_{CC} | (mW) | N_{CC} | (mW) | N_{CC} |
| 500 | 32.81 | 10 | 24.26 | 4 | 18.64 | 2 | 10.20 | 1 |
| 1000 | 60.48 | 20 | 41.08 | 8 | 33.52 | 4 | 20.39 | 2 |
| 2000 | 113.52 | 40 | 77.47 | 16 | 59.60 | 8 | 46.25 | 4 |

For example, the UE 115-a may transmit the one or more sidelink messages via a plurality of carriers of the communication link 215. For example, the UE 115-a may utilize a transmit power that may satisfy the transmit power constraint, and may be based on the time-division multiplexing configuration and on an emission regulation, to transmit the one or more sidelink messages via the plurality of carriers. The UE 115-b may communicate the one or more sidelink messages to the XR device 205-a according to a frequency-domain multiplexing pattern, a time-domain multiplexing pattern, or a combination thereof.

As described herein with reference to Table 5 and Table 6, a larger CC BW and FFT size (e.g., and correspondingly fewer CCs in CA for each UE 115-a and XR device 205 pairing) may be associated with efficient power consumption. In some cases, this efficiency may be due in part to digital front end (DFE) (e.g., not including FFT) functionality under a large CA scenario being associated with a higher complexity than a high FFT size related complexity. In some cases, it may be beneficial to utilize single CC operation until the associated FFT size becomes unreasonable (e.g., the upper bound for FFT size for UWB channels may be ˜8K). In some examples, some spectral fractions that may be utilized (e.g., occupied) by licensed transmissions (e.g., some more loaded native UWB channels or some narrow band interference over UWB, such as some satellite transmissions on the overlapping frequencies) may be excluded as options. However, until this exclusion, lower CC BW options of 0.5 GHz and 1 GHz coupled with a noncontiguous CA support may be utilized and configured for each UE 115-a and XR device 205 pairing (e.g., depending on scenario).

One or more of the implementations, as described herein with reference to FIGS. 2 and Tables 1-6, may be summarized in Table 7. In some examples, one or more other implementations may not be described or depicted in Table 7. In some other examples, one or more implementations or aspects of implementations as summarized in Table 7 may be combined.

TABLE 7
Summary of Implementations

| | | | | | CC | | CA |
|---|---|---|---|---|---|---|---|
| | | | | SCS | BW | FFT | Options |
| Implementation | Constraints | Benefit | Downside | (kHz) | (GHz) | Size | (N_{CC}) |
| First | No FCC min. | No FCC | Excessive | 120 | 0.5 | 8192 | 1, 2, 3, 4 |
| Implementation | BW | requirement | FFT size per | | | (Radix- 2/4) | |
| (Table 1) | requirement | relaxations; | CC; only min | | | | |
| | relaxation; | NR | CC BW | | | | |
| | radix 2/4 FFT | numerologies | option | | | | |
| | sizes; max. 8k | reused; | (0.5 GHz) | | | | |
| | FFT size | no need | can be | | | | |
| | limitation; 5G | for extra | supported; | | | | |
| | NR | timeline | high quantity | | | | |
| | numerology | alignments | of CCs | | | | |
| | and SCS | between | required to | | | | |
| | options | UWB | support high | | | | |
| | preserved | and NR; | BW | | | | |
| | | Low | (complex | | | | |
| | | complexity | DFE) | | | | |
| | | FFT type | | | | | |
| | | (Radix-2) | | | | | |
| Second | No FCC min. | No FCC | No reuse for | 62.5 | 0.5 | 8192 | 1, 2, 3, 4 |
| Implementation | BW | requirement | NR | | | (Radix- 2/4) | |
| (Table 2) | requirement | relaxations; | numerologies; | | | | |
| | relaxation; | low | extra | 125 | 0.51 | 4096 | 1, 2, 3, 4 |
| | radix 2/4 FFT | complexity | timeline | | | 8192 | 1, 2 |
| | sizes; max. 8k | FFT type | alignment | | | (Radix- 2/4) | |
| | FFT size | (Radix-2); | needed | | | | |
| | limitation; 5G | FFT size | between | | | | |
| | NR | aligned | UWB and | | | | |
| | numerology | with CC | NR | | | | |
| | and SCS | BW; two | | | | | |
| | options | numerology | | | | | |
| | modified | options | | | | | |
| | | and two | | | | | |
| | | CC BW | | | | | |
| | | options | | | | | |
| | | supported; | | | | | |
| | | lower | | | | | |
| | | quantity | | | | | |
| | | of CCs | | | | | |
| | | may be | | | | | |
| | | used to | | | | | |
| | | support a | | | | | |
| | | high BW | | | | | |
| | | (lower | | | | | |
| | | complexity); | | | | | |
| | | allows | | | | | |
| | | lowest | | | | | |
| | | power | | | | | |
| | | consumption | | | | | |
| | | on XR side | | | | | |
| Third | No FCC min. | No FCC | Higher | 60 | 0.5 | 8640 | 1, 2, 3, 4 |
| Implementation | BW | requirement | complexity | | | (comp. | |
| (Table 3) | requirement | relaxations; | FFT type | | | radix, | |
| | relaxation; | FFT size | (comp. radix) | | | (m = 6, | |
| | composite | aligned | | | | p = 3, | |
| | radix FFT sizes | with CC | | | | q = 1) | |
| | assumed; max. | BW; two | | | | | |
| | 8k FFT size | numerology | | | | | |
| | limitation; 5G | options | | | | | |
| | NR | and two | | | | | |
| | numerology | CC BW | | | | | |
| | and SCS | options | | | | | |
| | options | supported; | | | | | |
| | preserved | lower | | | | | |
| | | quantity | | | | | |
| | | of CCs | | 120 | 0.51 | 4320 | 1, 2, 3, 4 |
| | | can be | | | | 8640 | 1, 2 |
| | | used to | | | | (comp. | |
| | | support a | | | | radix) | |
| | | high BW | | | | | |
| | | (lower | | | | | |
| | | complexity); | | | | | |
| | | NR | | | | | |
| | | numerologies | | | | | |
| | | reused; | | | | | |
| | | no need | | | | | |
| | | for extra | | | | | |
| | | timeline | | | | | |
| | | alignment | | | | | |
| | | between | | | | | |
| | | UWB | | | | | |
| | | and NR | | | | | |
| Fourth | FCC min. BW | NR | Requires | 62.5 | 0.5 | 8192 | 1, 2, 3, 4 |
| Implementation | requirement | numerologies | slight | | | (radix- 2/4) | |
| (Table 4) | slightly | reused, | relaxation of | 125 | 0.51 | 4096 | 1, 2, 3, 4 |
| | relaxed; radix | no need | FCC min | | | 8192 | 1, 2 |
| | 2/4 FFT sizes; | for extra | BW requirement | | | (radix- 2/4) | |
| | max. 8k FFT | timeline | for UWB | | | | |
| | size limitation; | alignments | based | | | | |
| | 5G NR | between | sidelink | | | | |
| | numerology | UWB | (from 0.5 | | | | |
| | and SCS | and NR; | GHz to 0.492 | | | | |
| | options | low | GHz) | | | | |
| | preserved | complexity | | | | | |
| | | FFT type | | | | | |
| | | (radix-2); | | | | | |
| | | FFT size | | | | | |
| | | aligned | | | | | |
| | | with CC | | | | | |
| | | BW; two | | | | | |
| | | numerology | | | | | |
| | | options | | | | | |
| | | and two | | | | | |
| | | CC BW | | | | | |
| | | options | | | | | |
| | | supported; | | | | | |
| | | lower | | | | | |
| | | quantity | | | | | |
| | | of CCs | | | | | |
| | | may be | | | | | |
| | | used to | | | | | |
| | | support a | | | | | |
| | | high BW | | | | | |
| | | (lower | | | | | |
| | | complexity); | | | | | |
| | | allows | | | | | |
| | | lowest | | | | | |
| | | power | | | | | |
| | | consumption | | | | | |
| | | on XR side | | | | | |

The use of pre-defined sets of parameters as described herein may enable high BW communications between the UE 115-a and the XR device 205 while reducing the processing required at the XR device 205. As such, techniques described herein may enable the reduction of the XR device 205 size, leading to more comfortable user fit and experience. Additionally, by reducing the processing performed at the XR device 205, the battery life of the XR device 205 may be improved.

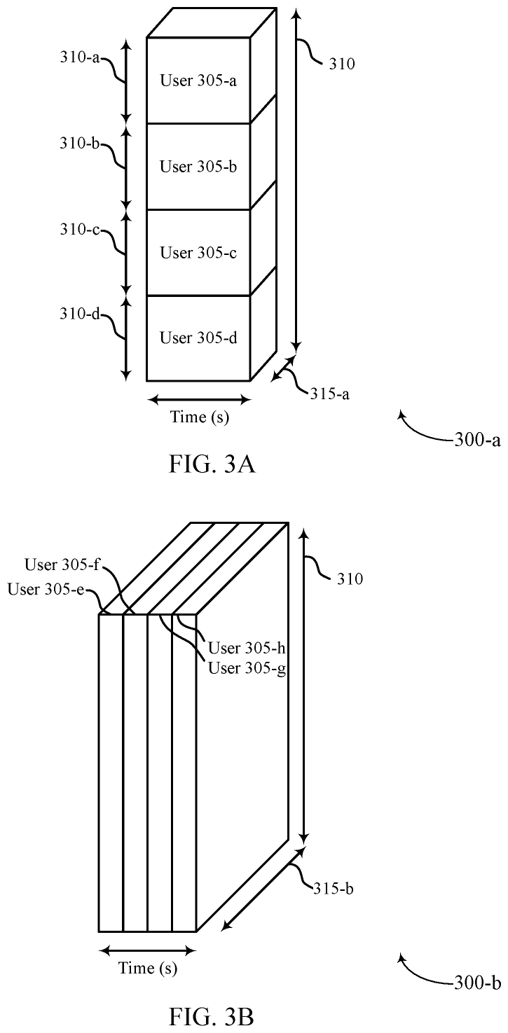

FIGS. 3A and 3B show examples of a resource configuration 300-a and a resource configuration 300-b that support techniques for UWB-based sidelink communications in accordance with one or more aspects of the present disclosure. Aspects of the resource configuration 300-a and resource configuration 300-b may implement, or be implemented by, aspects of the wireless communications system 100, the wireless communications system 200, or both. For example, the resource configuration 300-a and resource configuration 300-b may illustrate configuration options that may be utilized in multiplexing one or more user signals 305 (e.g., a user signal 305-a, a user signal 305-b, a user signal 305-c, a user signal 305-d, a user signal 305-c, a user signal 305-f, a user signal 305-g, a user signal 305-h) in time, according to BW 310 (e.g., including BW 310-a, BW 310-b, BW 310-c, and BW 310-d in some examples) and transmission power 315 (e.g., transmission power 315-a, transmission power 315-b). In some examples, each of the one or more user signals 305 may be associated with one or more XR devices, which may be examples of an XR device 205 as described with reference to FIG. 2.

To increase efficiency in utilization of UWB resources, a UE may adjust for multiuser access of an unlicensed channel (e.g., a UWB-based sidelink). As described herein, the UE may identify one or more users (e.g., one or more other XR devices) on an unlicensed channel and may multiplex the associated signals. For example, the UE may identify one or more other XR devices on a UWB-based sidelink and may multiplex the one or more user signals 305 of the XR devices via an FD multiplexing configuration, a TD multiplexing configuration, or both, throughout the time interval. The UE may also communicate with the one or more XR devices according to the frequency-domain multiplexing configuration, the time-domain multiplexing configuration, or both. Additionally, the UE may communicate the multiplexed communications to the XR devices based on a quantity of the XR devices, an emission regulation, or both.

In some examples, the UE may multiplex the one or more user signals 305 (e.g., the user signals 305-a, user signals 305-b, user signals 305-c, user signals 305-d) according to a FD multiplexing configuration (e.g., the resource configuration 300-a). For example, for a total BW 310 of 2 GHz, each of the user signals BWs (e.g., the BW 310-a, the BW 310-b, the BW 310-c, the BW 310-d) may include an allocated portion (e.g., 25%) of the total BW 310 according to B=N·1 MHz for the duration (e.g., a 1 ms time period), where B is the allocated BW for each of the N user signals 305. In this case, the transmission power 315-a may be calculated according to P=P₀·N@T₀, where P represents the transmission power 315-a per user signal over the duration, P₀ represents a power restriction value (e.g., −41 dBm/MHz), N is the quantity of user signals 305 (e.g., 4), and T₀ represents the duration (e.g., a 1 ms time period).

It may be beneficial to enable the UE to multiplex the one or more user signals 305 of one or more XR device and UE pairs according to a TD multiplexing configuration including a duty cycle limit for each XR device (e.g., each of the user signal 305-e, the user signal 305-f, the user signal 305-g, and the user signal 305-h). For example, in order to increase efficiency of utilization of UWB-based sidelink resources, TD multiplexing may be utilized. In the case that the user signals 305 utilize the same BW, TD multiplexing the user signals 305 over a higher BW (e.g., with transmission duty cycle reduction) may be more beneficial when communicating via a UWB-based channel than FD multiplexing (e.g., with total transmission duty cycle for each user signal over proportional total BW fraction) of the same quantity of user signals 305.

In some examples, the UE may multiplex the one or more user signals 305 (e.g., the user signals 305-e, user signals 305-f, user signals 305-g, user signals 305-h) according to a TD multiplexing configuration (e.g., the resource configuration 300-b). For example, for a total BW 310 of 2 GHz, each of the user signals (e.g., the 4 user signals) may include the total BW 310 according to B=4N·1 MHz for the duration, where B is the allocated BW for each of the N user signals 305 during a duration (e.g., a 1 ms time period). In this case, the transmission power 315-b may be calculated according to

$$P = 4 {P}_{0} \cdot B \cdot \frac{1}{4} @ {T}_{0} = 4 {P}_{0} \cdot 4 N \cdot \frac{1}{4} @ {T}_{0} = 4 {P}_{0} \cdot N @ {T}_{0} ,$$

where P represents the transmission power 315-b per user signal 305 over the duration, P₀ represents a power restriction value (e.g., −41 dBm/MHz), N is the quantity of user signals 305 (e.g., 4), and To represents the duration (e.g., a 1 ms time period). As described herein, TD multiplexing of the user signals 305 over a higher BW may allow for an increase in transmission power for each of the user signals while preserving the same aggregative amount of TD-FD resources used by each XR device (e.g., according to the required capacity for XR applications). In some examples, a high BW for each user signal 305 may require the use of adjusted CA options in order to not violate the targeted maximum FFT size constraint (e.g., as further described with reference to FIG. 2).

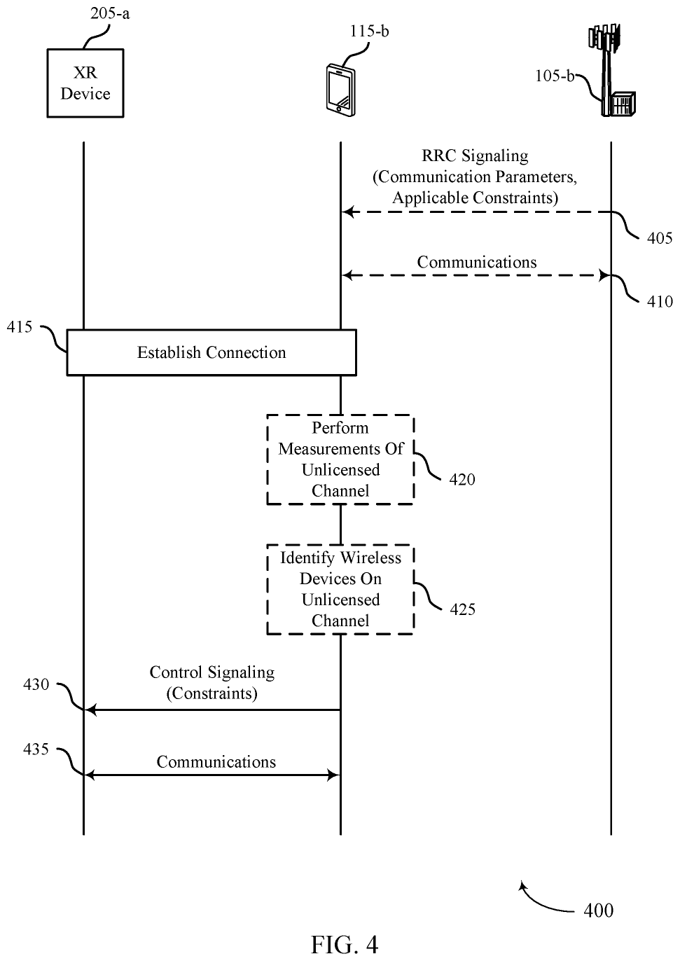

FIG. 4 shows an example of a process flow 400 that supports techniques for UWB-based sidelink communications in accordance with one or more aspects of the present disclosure. Aspects of the process flow 400 may implement, or be implemented by, aspects of the wireless communications system 100, the wireless communications system 200, or both. For example, the process flow 400 illustrates signaling and configurations that enable the utilization of pre-defined wireless communications parameters for communications between XR devices and UEs depending on the applicable constraints and restrictions placed on an associated UWB channel.

The process flow 400 includes an XR device 205-a, a UE 115-b and a network entity 105-b, which may be examples of XR devices 205, UEs 115, network entities 105, and other wireless devices as described herein. For example, the XR device 205-a, the UE 115-b, and the network entity 105-b illustrated in FIG. 4 may include examples of the XR device 205, the UE 115-a and the network entity 105-a, respectively, as illustrated in FIG. 2.

In some examples, the operations illustrated in process flow 400 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-b may receive RRC signaling from the network entity 105-b. The RRC signaling may include various communication parameters and applicable constraints for communications via an unlicensed wireless communications channel (e.g., the UWB channel). For example, the RRC signaling may indicate an SCS numerology that may be associated with one or more SCSs for communicating with the network entity 105-b.

At 410, the UE 115-b may communicate with the network entity 105-b. For example, the UE 115-b may communicate one or more messages with the network entity 105-b according to the one or more SCSs associated with the SCS numerology, according to one or more radix FFT sizes, or a combination thereof.

At 415, the UE 115-b may establish a connection with the XR device 205-a. For example, the UE 115-b may establish a wireless connection with the XR device 205-a via the unlicensed channel (e.g., the UWB channel).

At 420, the UE 115-b may perform one or more measurements of the unlicensed channel. For example, in response to establishing the connection with the XR device 205-a, the UE 115-b may perform one or more measurements for use in communications with the XR device 205-a via the unlicensed channel (e.g., the UWB channel).

At 425, the UE 115-b may identify one or more other wireless communications devices on the unlicensed channel. For example, in response to performing the one or more measurements of the unlicensed channel, the UE 115-b may identify one or more other XR devices 205 (e.g., such that the XR device 205-a may be one device of a plurality of wireless communications devices) that may perform wireless communications multiplexed via the unlicensed channel.

At 430, the UE 115-b may transmit control signaling to the XR device 205-a. The control signaling may include a communications configuration that indicate one or more constraints or parameters for communicating within the unlicensed channel. For example, the one or more constraints indicated by the communications configuration of the control signaling may include a minimum BW of the unlicensed channel, an FFT constraint, an SCS constraint, a transmit power constraint associated with communications transmitted via the unlicensed channel over a time interval, or any combination thereof. The UE 115-b may transmit the control signaling to the XR device 205-a based on receiving the RRC signaling from the network entity 105-b (e.g., at 405).

In some cases, the SCS constraint associated with communications over the unlicensed channel and indicated by the control signaling may include an expansion of the SCS numerology (e.g., received at the UE 115-b from the network entity 105-b at 405) to include one or more additional SCSs within the SCS numerology. As such, the SCS used in communications between the UE 115-b and the XR device 205-a may be different from the one or more SCS received at the UE 115-b (e.g., transmitted by the network entity 105-b) based on the expansion of the SCS numerology.

The FFT constraint may also include a composite radix size constraint. In the case that the FFT constraint may include a composite radix size constraint, the FFT size for communicating with the XR device 205-a (e.g., communicating one or more sidelink messages with the XR device 205-a) may be different from the one or more radix FFT sizes used for communications between the network entity 105-b and the UE 115-b based on the composite radix size constraint. For example, the one or more radix FFT sizes used for communications between the network entity 105-b and the UE 115-b may include Radix 2, Radix 3, Radix 5, or any combination thereof, while the FFT size used by the UE 115-b in communicating one or more sidelink messages with the XR device 205-a may be based on the composite radix size constraint and according to a Cooley Tukey algorithm, or a prime factor algorithm, or both.

At 435, the UE 115-b may communicate with the XR device 205-a. For example, in response to receiving the RRC signaling, the UE 115-b may communicate one or more sidelink messages with the XR device 205-a via the unlicensed channel using a set of communications parameters determined based on the communications configuration indicating the constraints and based on the measurements of the unlicensed channel. The set of communications parameters may include a component carrier BW, an FFT size, an SCS, or a combination thereof.

For example, in the case that the one or more constraints transmitted by the UE 115-b (e.g., at 430) may include a BW constraint of 500 MHz minimum BW, the FFT constraint may include an 8 k FFT size constraint, and the SCS constraint may include an expansion of an SCS numerology to include one or more additional SCSs (e.g., as described herein), the communication parameters utilized in the sidelink message communication (e.g., at 435) may include a component carrier BW of 500 MHz, an FFT size of 8192, and an SCS of 62.5 kHz. In other examples, the communication parameters utilized in the sidelink message communication (e.g., at 435) may include a component carrier BW of 1000 MHz, an FFT size of 8192, and an SCS of 125 kHz.

In another example, in the case that the one or more constraints transmitted by the UE 115-b (e.g., at 430) may include a BW constraint of 500 MHz minimum BW, the FFT constraint may include a 4 k FFT size constraint, and the SCS constraint may include an expansion of an SCS numerology to include one or more additional SCSs (e.g., as described herein), the communication parameters utilized in the sidelink message communication (e.g., at 435) may include a component carrier BW of 500 MHz, an FFT size of 4096, and an SCS of 125 kHz.

In another example, in the case that the one or more constraints transmitted by the UE 115-b (e.g., at 430) may include a BW constraint of 500 MHz minimum BW, the FFT constraint may include a 8 k FFT size constraint, and the SCS constraint may include an SCS of 60 kHz or 120 kHz, the communication parameters utilized in the sidelink message communication (e.g., at 435) may include a component carrier BW of 983 MHz, the FFT size of 8192, and the SCS of 120 kHz. In such a case, the FFT constraint may also include a radix 2 or radix 4 FFT constraint.

For example, in the case that the one or more constraints transmitted by the UE 115-b (e.g., at 430) may include a BW constraint of 500 MHz minimum BW, the FFT constraints may include a 8 k FFT size constraint and a composite radix size constraint, and the SCS constraint may include a preservation of SCS numerology, the communication parameters utilized in the sidelink message communication (e.g., at 435) may include a component carrier BW of 500 MHz, an FFT size of 8640, and an SCS of 60 kHz.

In another example, in the case that the one or more constraints transmitted by the UE 115-b (e.g., at 430) may include a BW constraint of 500 MHz minimum BW, the FFT constraints may include a 8 k FFT size constraint and a composite radix size constraint, and the SCS constraint may include a preservation of an SCS numerology to maintain a minimum quantity of usable SCSs within the SCSs numerology, the communication parameters utilized in the sidelink message communication (e.g., at 435) may include a component carrier BW of 500 MHz, an FFT size of 4320, and an SCS of 120 kHz. In other examples, the communication parameters utilized in the sidelink message communication (e.g., at 435) may include a component carrier BW of 1000 MHz, an FFT size of 8640, and an SCS of 120 kHz.

In another example, in the case that the one or more constraints transmitted by the UE 115-b (e.g., at 430) may include a BW relaxation constraint of 500 MHZ minimum BW, the FFT constraints may include a 8 k FFT size constraint, and the SCS constraint may include a preservation of an SCS numerology to maintain a minimum quantity of usable SCSs within the SCS numerology, the communication parameters utilized in the sidelink message communication (e.g., at 435) may include a component carrier BW of 491 MHz, an FFT size of 8192, and an SCS of 60 kHz. In other examples, the communication parameters utilized in the sidelink message communication (e.g., at 435) may include a component carrier BW of 491 MHz, an FFT size of 4096, and an SCS of 120 kHz.

In another example, in the case that the one or more constraints transmitted by the UE 115-b (e.g., at 430) may include a BW relaxation constraint of 1000 MHz minimum BW, the FFT constraints may include a 8 k FFT size constraint, and the SCS constraint may include a preservation of an SCS numerology to maintain a minimum quantity of usable SCSs within the SCS numerology, the communication parameters utilized in the sidelink message communication (e.g., at 435) may include a component carrier BW of 983 MHz, an FFT size of 8192, and an SCS of 120 kHz.

In some examples, the UE 115-b may transmit the one or more sidelink messages via a plurality of carriers of the unlicensed channel. For example, the UE 115-b may utilize a transmit power that may satisfy the transmit power constraint, and may be based on the time-division multiplexing configuration and on an emission regulation, to transmit the one or more sidelink messages via the plurality of carriers. The UE 115-b may communicate the one or more sidelink messages to the XR device 205-a according to a frequency-domain multiplexing pattern, a time-domain multiplexing pattern, or a combination thereof.

In the case that the UE 115-b may identify one or more other XR devices 205 on the unlicensed channel (e.g., at 425), the UE 115-b may multiplex the one or more sidelink messages via a time-division multiplexing configuration with additional communications performed by the additional XR devices 205 throughout the time interval. The UE 115-b may communicate the one or more sidelink messages to the XR device 205-a multiplexed with the additional communications for the additional XR devices 205 according to the frequency-domain multiplexing pattern, the time-domain multiplexing pattern, or a combination thereof. Additionally, the UE 115-b may communicate the multiplexed communications to the XR devices 205 based on a quantity of the XR devices, an emission regulation, or both.

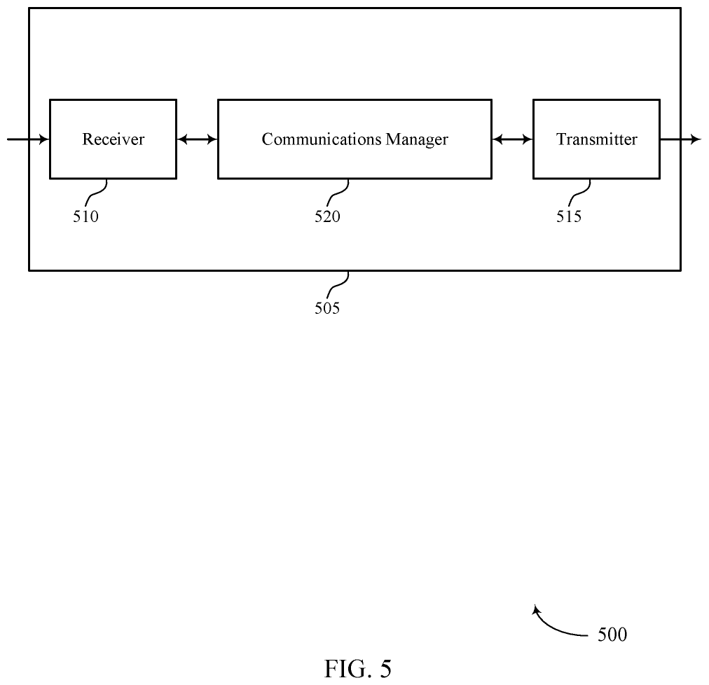

FIG. 5 shows a block diagram 500 of a device 505 that supports techniques for UWB-based sidelink communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for UWB-based sidelink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for UWB-based sidelink communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for UWB-based sidelink communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code such as processor-executable code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for establishing a wireless connection with a wireless communications device via an unlicensed wireless communications channel. The communications manager 520 is capable of, configured to, or operable to support a means for transmitting control signaling to the wireless communications device, the control signaling including a communications configuration that indicates one or more constraints for communicating within the unlicensed wireless communications channel, the one or more constraints including a minimum bandwidth of the unlicensed wireless communications channel, a Fourier transform constraint, an SCS constraint, or any combination thereof. The communications manager 520 is capable of, configured to, or operable to support a means for communicating one or more sidelink messages with the wireless communications device via the unlicensed wireless communications channel using a set of communications parameters determined based on the communications configuration, where the set of communications parameters include a component carrier bandwidth, an FFT size, and an SCS.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for high BW communications between a UE and an XR device while reducing the processing required at the XR device. As such, techniques described herein may enable the reduction of XR device size, leading to more comfortable user fit and experience. Additionally, by reducing the processing performed at the XR device, the battery life of the XR device may be improved.

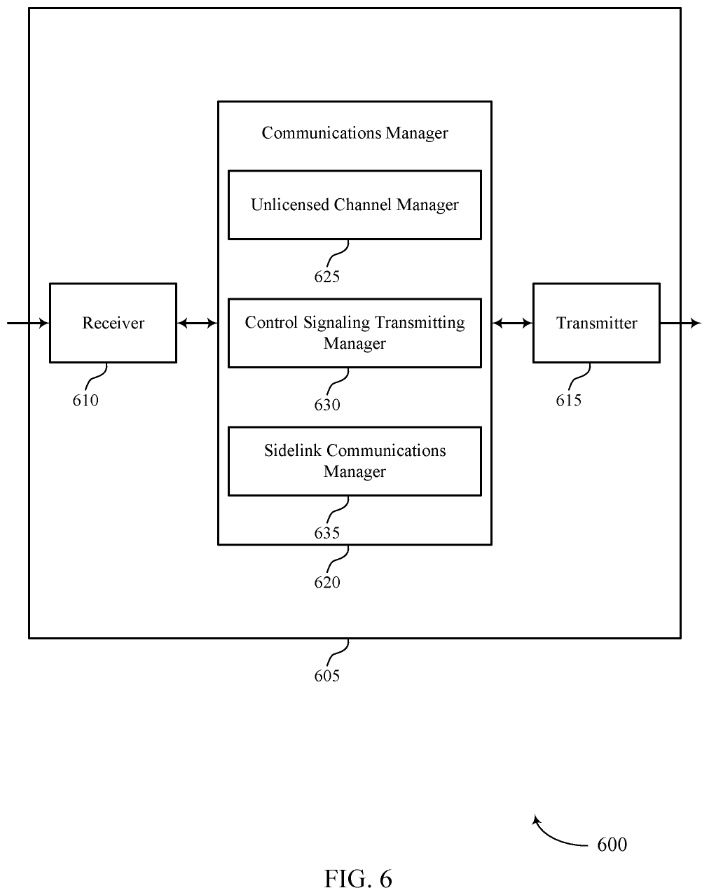

FIG. 6 shows a block diagram 600 of a device 605 that supports techniques for UWB-based sidelink communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for UWB-based sidelink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for UWB-based sidelink communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for UWB-based sidelink communications as described herein. For example, the communications manager 620 may include an unlicensed channel manager 625, a control signaling transmitting manager 630, a sidelink communications manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The unlicensed channel manager 625 is capable of, configured to, or operable to support a means for establishing a wireless connection with a wireless communications device via an unlicensed wireless communications channel. The control signaling transmitting manager 630 is capable of, configured to, or operable to support a means for transmitting control signaling to the wireless communications device, the control signaling including a communications configuration that indicates one or more constraints for communicating within the unlicensed wireless communications channel, the one or more constraints including a minimum bandwidth of the unlicensed wireless communications channel, a Fourier transform constraint, an SCS constraint, or any combination thereof. The sidelink communications manager 635 is capable of, configured to, or operable to support a means for communicating one or more sidelink messages with the wireless communications device via the unlicensed wireless communications channel using a set of communications parameters determined based on the communications configuration, where the set of communications parameters include a component carrier bandwidth, an FFT size, and an SCS.

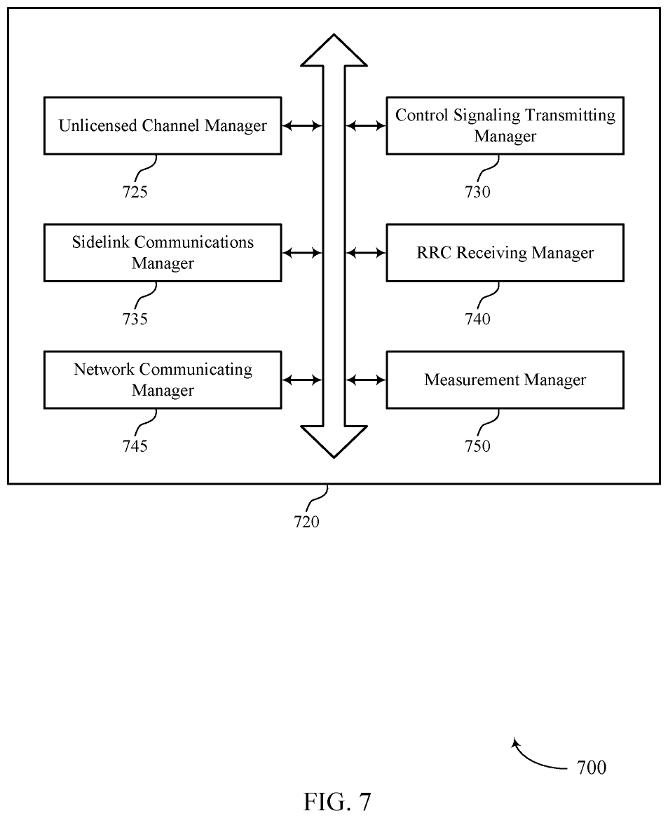

FIG. 7 shows a block diagram 700 of a communications manager 720 that supports techniques for UWB-based sidelink communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for UWB-based sidelink communications as described herein. For example, the communications manager 720 may include an unlicensed channel manager 725, a control signaling transmitting manager 730, a sidelink communications manager 735, an RRC receiving manager 740, a network communicating manager 745, a measurement manager 750, or any combination thereof. Each of these components, or components or subcomponents thereof (e.g., one or more processors, one or more memories), may communicate, directly or indirectly, with one another (e.g., via one or more buses).

The unlicensed channel manager 725 is capable of, configured to, or operable to support a means for establishing a wireless connection with a wireless communications device via an unlicensed wireless communications channel. The control signaling transmitting manager 730 is capable of, configured to, or operable to support a means for transmitting control signaling to the wireless communications device, the control signaling including a communications configuration that indicates one or more constraints for communicating within the unlicensed wireless communications channel, the one or more constraints including a minimum bandwidth of the unlicensed wireless communications channel, a Fourier transform constraint, an SCS constraint, or any combination thereof. The sidelink communications manager 735 is capable of, configured to, or operable to support a means for communicating one or more sidelink messages with the wireless communications device via the unlicensed wireless communications channel using a set of communications parameters determined based on the communications configuration, where the set of communications parameters include a component carrier bandwidth, an FFT size, and an SCS.

In some examples, the RRC receiving manager 740 is capable of, configured to, or operable to support a means for receiving, from a network entity, RRC signaling indicating an SCS numerology associated with one or more SCSs for communicating with the network entity. In some examples, the network communicating manager 745 is capable of, configured to, or operable to support a means for communicating one or more messages with the network entity in accordance with the one or more SCSs associated with the SCS numerology, where the SCS constraint associated with communications over the unlicensed wireless communications channel includes an expansion of the SCS numerology to include one or more additional SCSs within the SCS numerology, and where the SCS used to communicate the one or more sidelink messages with the wireless communications device is different from the one or more SCSs based on the expansion of the SCS numerology.

In some examples, the minimum bandwidth includes a 500 MHz minimum bandwidth constraint, the Fourier transform constraint includes an 8 k FFT size constraint, and the SCS constraint includes an expansion of an SCS numerology to include one or more additional SCSs. In some examples, the component carrier bandwidth includes 500 MHz, the FFT size includes 8192, and the SCS includes 62.5 kHz.

In some examples, the minimum bandwidth includes a 500 MHz minimum bandwidth constraint, the Fourier transform constraint includes an 4 k FFT size constraint, and the SCS constraint includes an expansion of an SCS numerology to include one or more additional SCSs. In some examples, the component carrier bandwidth includes 500 MHZ, the FFT size includes 4096, and the SCS includes 125 kHz.

In some examples, the minimum bandwidth includes a 500 MHz minimum bandwidth constraint, the Fourier transform constraint includes an 8 k FFT size constraint, and the SCS constraint includes an expansion of an SCS numerology to include one or more additional SCSs. In some examples, the component carrier bandwidth includes 1000 MHz, the FFT size includes 8192, and the SCS includes 125 kHz.

In some examples, the minimum bandwidth includes a 500 MHz bandwidth constraint, the Fourier transform constraint includes an 8 k FFT size constraint, and the SCS constraint includes an SCS of 60 kHz or 120 kHz. In some examples, the component carrier bandwidth includes 983 MHz, the FFT size includes 8192, and the SCS includes 120 kHz.

In some examples, the Fourier transform constraint further includes a radix 2 or radix 4 FFT constraint.

In some examples, the network communicating manager 745 is capable of, configured to, or operable to support a means for communicating one or more messages with a network entity in accordance with one or more radix FFT sizes, where the Fourier transform constraint includes a composite radix size constraint, and where the FFT size for communicating the one or more sidelink messages with the wireless communications device is different from the one or more FFT sizes based on the composite radix size constraint.

In some examples, the one or more radix FFT sizes include Radix 2, Radix 3, Radix 5, or any combination thereof. In some examples, the FFT size for communicating the one or more sidelink messages with the wireless communications device is determined based on the composite radix size constraint and in accordance with a Cooley Tukey algorithm, or a prime factor algorithm, or both.

In some examples, the minimum bandwidth includes a 500 MHz minimum bandwidth constraint, the Fourier transform constraint includes an 8 k FFT size constraint and a composite radix size constraint, and the SCS constraint includes a preservation of SCS numerology. In some examples, the component carrier bandwidth includes 500 MHz, the FFT size includes 8640, and the SCS includes 60 KHz.

In some examples, the minimum bandwidth includes a 500 MHz minimum bandwidth constraint, the Fourier transform constraint includes an 8 k FFT size constraint and a composite radix size constraint, and the SCS constraint includes a preservation of an SCS numerology to maintain a minimum quantity of usable SCSs within the SCS numerology. In some examples, the component carrier bandwidth includes 500 MHz, the FFT size includes 4320, and the SCS includes 120 KHz.

In some examples, the minimum bandwidth includes a 500 MHz minimum bandwidth constraint, the Fourier transform constraint includes an 8 k FFT size constraint and a composite radix size constraint, and the SCS constraint includes a preservation of an SCS numerology to maintain a minimum quantity of usable SCSs within the SCS numerology. In some examples, the component carrier bandwidth includes 1000 MHz, the FFT size includes 8640, and the SCS includes 120 kHz.

In some examples, the minimum bandwidth includes a relaxation of a 500 MHz minimum bandwidth constraint, the Fourier transform constraint includes an 8 k FFT size constraint, and the SCS constraint includes a preservation of an SCS numerology to maintain a minimum quantity of usable SCSs within the SCS numerology. In some examples, the component carrier bandwidth includes 491 MHZ, the FFT size includes 8192, and the SCS includes 60 KHz.

In some examples, the minimum bandwidth includes a relaxation of a 500 MHz minimum bandwidth constraint, the Fourier transform constraint includes an 8 k FFT size constraint, and the SCS constraint includes a preservation of an SCS numerology to maintain a minimum quantity of usable SCSs within the SCS numerology. In some examples, the component carrier bandwidth includes 491 MHZ, the FFT size includes 4096, and the SCS includes 120 KHz.

In some examples, the minimum bandwidth includes a relaxation of a 1000 MHz minimum bandwidth constraint, the Fourier transform constraint includes an 8 k FFT size constraint, and the SCS constraint includes a preservation of an SCS numerology to maintain a minimum quantity of usable SCSs within the SCS numerology. In some examples, the component carrier bandwidth includes 983 MHZ, the FFT size includes 8192, and the SCS includes 120 kHz.

In some examples, the measurement manager 750 is capable of, configured to, or operable to support a means for performing measurements for the unlicensed wireless communications channel. In some examples, the unlicensed channel manager 725 is capable of, configured to, or operable to support a means for identifying, based on the measurements, a set of multiple wireless communications devices including the wireless communications device that are to perform wireless communications multiplexed via the unlicensed wireless communications channel, where the one or more sidelink messages communicated with the wireless communications device are multiplexed with additional sidelink messages communicated with the set of multiple wireless communications devices in accordance with a frequency-domain multiplexing pattern, a time-domain multiplexing pattern, or both, based on a quantity of wireless communications devices included within the set of multiple wireless communications devices, an emission regulation, or both.

In some examples, a transmit power used to communicate the one or more sidelink messages is based on the emission regulation and whether the one or more sidelink messages are communicated in accordance with the frequency-domain multiplexing pattern, the time-domain multiplexing pattern, or both.

In some examples, the RRC receiving manager 740 is capable of, configured to, or operable to support a means for receiving, from a network entity, RRC signaling indicating the one or more constraints for communicating within the unlicensed wireless communications channel, where transmitting the control signaling, communicating the one or more sidelink messages, or both, is based on receiving the RRC signaling.

In some examples, the measurement manager 750 is capable of, configured to, or operable to support a means for performing measurements for communications performed with the wireless communications device via the unlicensed wireless communications channel based on establishing the wireless channel with the wireless communications device, where the set of communications parameters are determined based on the measurements.

In some examples, to support communicating the one or more sidelink messages, the sidelink communications manager 735 is capable of, configured to, or operable to support a means for transmitting the one or more sidelink messages via a set of multiple carriers of the unlicensed wireless communications channel using a transmit power that satisfies the transmit power constraint.

In some examples, the one or more constraints further include a transmit power constraint associated with communications transmitted via the wireless communications channel over a time interval. In some examples, the one or more sidelink messages are multiplexed via time-division multiplexing configuration with additional communications performed by a set of multiple additional wireless communications devices throughout the time interval. In some examples, a transmit power used to communicate the one or more sidelink messages is based on the transmit power constraint and the time-division multiplexing configuration.

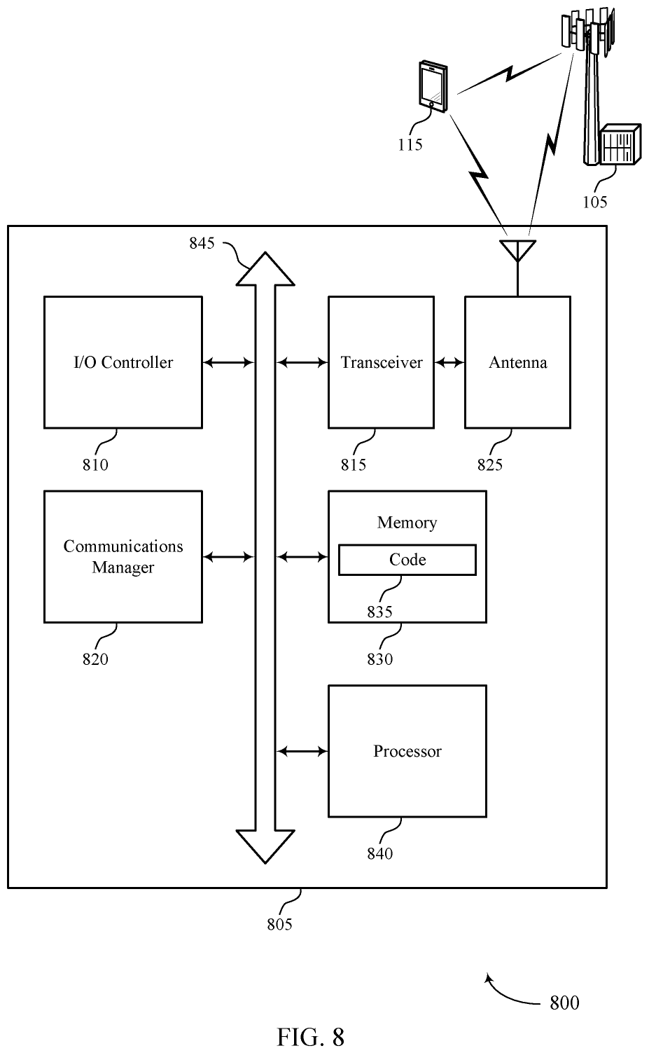

FIG. 8 shows a diagram of a system 800 including a device 805 that supports techniques for UWB-based sidelink communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for UWB-based sidelink communications). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

For example, the communications manager 820 is capable of, configured to, or operable to support a means for establishing a wireless connection with a wireless communications device via an unlicensed wireless communications channel. The communications manager 820 is capable of, configured to, or operable to support a means for transmitting control signaling to the wireless communications device, the control signaling including a communications configuration that indicates one or more constraints for communicating within the unlicensed wireless communications channel, the one or more constraints including a minimum bandwidth of the unlicensed wireless communications channel, a Fourier transform constraint, an SCS constraint, or any combination thereof. The communications manager 820 is capable of, configured to, or operable to support a means for communicating one or more sidelink messages with the wireless communications device via the unlicensed wireless communications channel using a set of communications parameters determined based on the communications configuration, where the set of communications parameters include a component carrier bandwidth, an FFT size, and an SCS.

By including or configuring the communications manager 820 in accordance with examples as described herein, the device 805 may support techniques for reduction of XR device size, leading to more comfortable user fit and experience. Additionally, by reducing the processing performed at the XR device, the battery life of the XR device may be improved.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for UWB-based sidelink communications as described herein, or the at least one processor 840 and the at least one memory 830 may be otherwise configured to, individually or collectively, perform or support such operations.

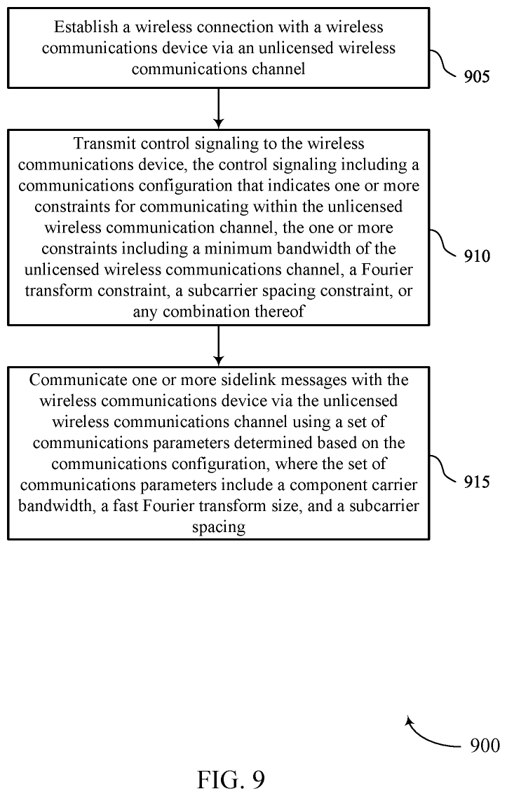

FIG. 9 shows a flowchart illustrating a method 900 that supports techniques for UWB-based sidelink communications in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include establishing a wireless connection with a wireless communications device via an unlicensed wireless communications channel. The operations of block 905 may be performed in accordance with examples as disclosed herein. In some examples, aspects of the operations of 905 may be performed by an unlicensed channel manager 725 as described with reference to FIG. 7.

At 910, the method may include transmitting control signaling to the wireless communications device, the control signaling including a communications configuration that indicates one or more constraints for communicating within the unlicensed wireless communications channel, the one or more constraints including a minimum bandwidth of the unlicensed wireless communications channel, a Fourier transform constraint, an SCS constraint, or any combination thereof. The operations of block 910 may be performed in accordance with examples as disclosed herein. In some examples, aspects of the operations of 910 may be performed by a control signaling transmitting manager 730 as described with reference to FIG. 7.

At 915, the method may include communicating one or more sidelink messages with the wireless communications device via the unlicensed wireless communications channel using a set of communications parameters determined based on the communications configuration, where the set of communications parameters include a component carrier bandwidth, an FFT size, and an SCS. The operations of block 915 may be performed in accordance with examples as disclosed herein. In some examples, aspects of the operations of 915 may be performed by a sidelink communications manager 735 as described with reference to FIG. 7.

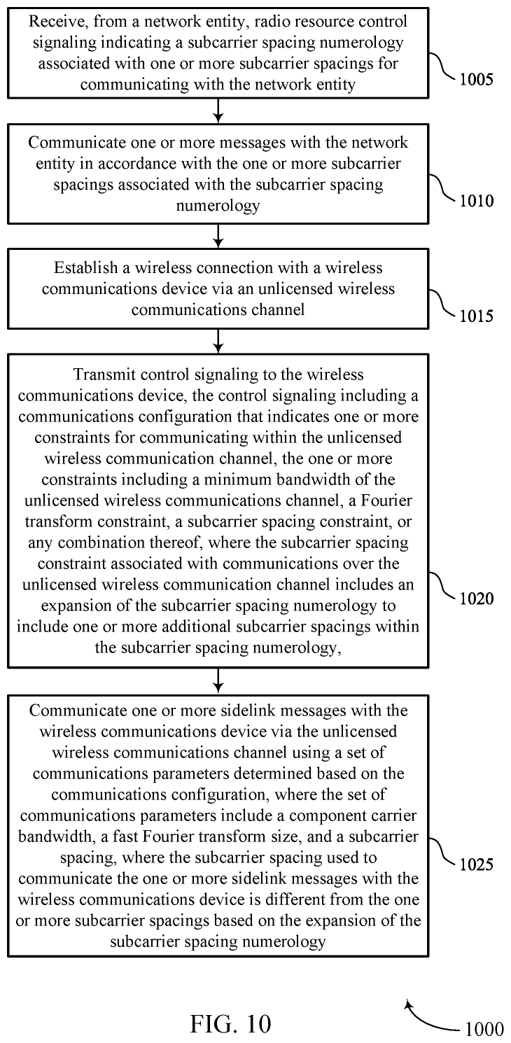

FIG. 10 shows a flowchart illustrating a method 1000 that supports techniques for UWB-based sidelink communications in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a network entity, RRC signaling indicating an SCS numerology associated with one or more SCSs for communicating with the network entity. The operations of block 1005 may be performed in accordance with examples as disclosed herein. In some examples, aspects of the operations of 1005 may be performed by an RRC receiving manager 740 as described with reference to FIG. 7.

At 1010, the method may include communicating one or more messages with the network entity in accordance with the one or more SCSs associated with the SCS numerology. The operations of block 1010 may be performed in accordance with examples as disclosed herein. In some examples, aspects of the operations of 1010 may be performed by a network communicating manager 745 as described with reference to FIG. 7.

At 1015, the method may include establishing a wireless connection with a wireless communications device via an unlicensed wireless communications channel. The operations of block 1015 may be performed in accordance with examples as disclosed herein. In some examples, aspects of the operations of 1015 may be performed by an unlicensed channel manager 725 as described with reference to FIG. 7.

At 1020, the method may include transmitting control signaling to the wireless communications device, the control signaling including a communications configuration that indicates one or more constraints for communicating within the unlicensed wireless communications channel, the one or more constraints including a minimum bandwidth of the unlicensed wireless communications channel, a Fourier transform constraint, an SCS constraint, or any combination thereof, where the SCS constraint associated with communications over the unlicensed wireless communications channel includes an expansion of the SCS numerology to include one or more additional SCSs within the SCS numerology. The operations of block 1020 may be performed in accordance with examples as disclosed herein. In some examples, aspects of the operations of 1020 may be performed by a control signaling transmitting manager 730 as described with reference to FIG. 7.

At 1025, the method may include communicating one or more sidelink messages with the wireless communications device via the unlicensed wireless communications channel using a set of communications parameters determined based on the communications configuration, where the set of communications parameters include a component carrier bandwidth, an FFT size, and an SCS, where the SCS used to communicate the one or more sidelink messages with the wireless communications device is different from the one or more SCSs based on the expansion of the SCS numerology. The operations of block 1025 may be performed in accordance with examples as disclosed herein. In some examples, aspects of the operations of 1025 may be performed by a sidelink communications manager 735 as described with reference to FIG. 7.

The following provides an overview of aspects of the present disclosure:

Aspect 1: A method for wireless communications at a UE, comprising: establishing a wireless connection with a wireless communications device via an unlicensed wireless communications channel; transmitting control signaling to the wireless communications device, the control signaling comprising a communications configuration that indicates one or more constraints for communicating within the unlicensed wireless communication channel, the one or more constraints comprising a minimum bandwidth of the unlicensed wireless communications channel, a Fourier transform constraint, an SCS constraint, or any combination thereof; and communicating one or more sidelink messages with the wireless communications device via the unlicensed wireless communications channel using a set of communications parameters determined based at least in part on the communications configuration, wherein the set of communications parameters comprise a component carrier bandwidth, an FFT size, and an SCS.

Aspect 2: The method of aspect 1, further comprising: receiving, from a network entity, radio resource control signaling indicating an SCS numerology associated with one or more SCSs for communicating with the network entity; and communicating one or more messages with the network entity in accordance with the one or more SCSs associated with the SCS numerology, wherein the SCS constraint associated with communications over the unlicensed wireless communication channel comprises an expansion of the SCS numerology to include one or more additional SCSs within the SCS numerology, and wherein the SCS used to communicate the one or more sidelink messages with the wireless communications device is different from the one or more SCSs based at least in part on the expansion of the SCS numerology.

Aspect 3: The method of any of aspects 1 through 2, wherein the minimum bandwidth comprises a 500 MHz minimum bandwidth constraint, the Fourier transform constraint comprises an 8 k FFT size constraint, and the SCS constraint comprises an expansion of an SCS numerology to include one or more additional SCSs, and the component carrier bandwidth comprises 500 MHz, the FFT size comprises 8192, and the SCS comprises 62.5 kHz.

Aspect 4: The method of any of aspects 1 through 3, wherein the minimum bandwidth comprises a 500 MHz minimum bandwidth constraint, the Fourier transform constraint comprises an 4 k FFT size constraint, and the SCS constraint comprises an expansion of an SCS numerology to include one or more additional SCSs, and the component carrier bandwidth comprises 500 MHz, the FFT size comprises 4096, and the SCS comprises 125 kHz.

Aspect 5: The method of any of aspects 1 through 4, wherein the minimum bandwidth comprises a 500 MHz minimum bandwidth constraint, the Fourier transform constraint comprises an 8 k FFT size constraint, and the SCS constraint comprises an expansion of an SCS numerology to include one or more additional SCSs, and the component carrier bandwidth comprises 1000 MHz, the FFT size comprises 8192, and the SCS comprises 125 kHz.

Aspect 6: The method of any of aspects 1 through 5, wherein the minimum bandwidth comprises a 500 MHz bandwidth constraint, the Fourier transform constraint comprises an 8 k FFT size constraint, and the SCS constraint comprises an SCS of 60 kHz or 120 kHz, and the component carrier bandwidth comprises 983 MHz, the FFT size comprises 8192, and the SCS comprises 120 KHz.

Aspect 7: The method of aspect 6, wherein the Fourier transform constraint further comprises a radix 2 or radix 4 FFT constraint.

Aspect 8: The method of any of aspects 1 through 7, further comprising: communicating one or more messages with a network entity in accordance with one or more radix FFT sizes, wherein the Fourier transform constraint comprises a composite radix size constraint, and wherein the FFT size for communicating the one or more sidelink messages with the wireless communications device is different from the one or more FFT sizes based at least in part on the composite radix size constraint.

Aspect 9: The method of aspect 8, wherein the one or more radix FFT sizes comprise Radix 2, Radix 3, Radix 5, or any combination thereof, and the FFT size for communicating the one or more sidelink messages with the wireless communications device is determined based at least in part on the composite radix size constraint and in accordance with a Cooley Tukey algorithm, or a prime factor algorithm, or both.

Aspect 10: The method of any of aspects 1 through 9, wherein the minimum bandwidth comprises a 500 MHz minimum bandwidth constraint, the Fourier transform constraint comprises an 8 k FFT size constraint and a composite radix size constraint, and the SCS constraint comprises a preservation of SCS numerology, and the component carrier bandwidth comprises 500 MHz, the FFT size comprises 8640, and the SCS comprises 60 KHz.

Aspect 11: The method of any of aspects 1 through 10, wherein the minimum bandwidth comprises a 500 MHz minimum bandwidth constraint, the Fourier transform constraint comprises an 8 k FFT size constraint and a composite radix size constraint, and the SCS constraint comprises a preservation of an SCS numerology to maintain a minimum quantity of usable SCSs within the SCS numerology, and the component carrier bandwidth comprises 500 MHz, the FFT size comprises 4320, and the SCS comprises 120 kHz.

Aspect 12: The method of any of aspects 1 through 11, wherein the minimum bandwidth comprises a 500 MHz minimum bandwidth constraint, the Fourier transform constraint comprises an 8 k FFT size constraint and a composite radix size constraint, and the SCS constraint comprises a preservation of an SCS numerology to maintain a minimum quantity of usable SCSs within the SCS numerology, and the component carrier bandwidth comprises 1000 MHz, the FFT size comprises 8640, and the SCS comprises 120 KHz.

Aspect 13: The method of any of aspects 1 through 12, wherein the minimum bandwidth comprises a relaxation of a 500 MHz minimum bandwidth constraint, the Fourier transform constraint comprises an 8 k FFT size constraint, and the SCS constraint comprises a preservation of an SCS numerology to maintain a minimum quantity of usable SCSs within the SCS numerology, and the component carrier bandwidth comprises 491 MHz, the FFT size comprises 8192, and the SCS comprises 60 KHz.

Aspect 14: The method of any of aspects 1 through 13, wherein the minimum bandwidth comprises a relaxation of a 500 MHz minimum bandwidth constraint, the Fourier transform constraint comprises an 8 k FFT size constraint, and the SCS constraint comprises a preservation of an SCS numerology to maintain a minimum quantity of usable SCSs within the SCS numerology, and the component carrier bandwidth comprises 491 MHz, the FFT size comprises 4096, and the SCS comprises 120 KHz.

Aspect 15: The method of any of aspects 1 through 14, wherein the minimum bandwidth comprises a relaxation of a 1000 MHz minimum bandwidth constraint, the Fourier transform constraint comprises an 8 k FFT size constraint, and the SCS constraint comprises a preservation of an SCS numerology to maintain a minimum quantity of usable SCSs within the SCS numerology, and the component carrier bandwidth comprises 983 MHz, the FFT size comprises 8192, and the SCS comprises 120 kHz.

Aspect 16: The method of any of aspects 1 through 15, further comprising: performing measurements for the unlicensed wireless communications channel; identifying, based at least in part on the measurements, a plurality of wireless communications devices including the wireless communications device that are to perform wireless communications multiplexed via the unlicensed wireless communications channel, wherein the one or more sidelink messages communicated with the wireless communications device are multiplexed with additional sidelink messages communicated with the plurality of wireless communications devices in accordance with a frequency-domain multiplexing pattern, a time-domain multiplexing pattern, or both, based at least in part on a quantity of wireless communications devices included within the plurality of wireless communications devices, an emission regulation, or both.

Aspect 17: The method of any of aspects 1 through 16, wherein a transmit power used to communicate the one or more sidelink messages is based at least in part on the emission regulation and whether the one or more sidelink messages are communicated in accordance with the frequency-domain multiplexing pattern, the time-domain multiplexing pattern, or both.

Aspect 18: The method of any of aspects 1 through 17, further comprising: receiving, from a network entity, radio resource control signaling indicating the one or more constraints for communicating within the unlicensed wireless communications channel, wherein transmitting the control signaling, communicating the one or more sidelink messages, or both, is based at least in part on receiving the radio resource control signaling.

Aspect 19: The method of any of aspects 1 through 18, further comprising: performing measurements for communications performed with the wireless communications device via the unlicensed channel based at least in part on establishing the wireless channel with the wireless communications device, wherein the set of communications parameters are determined based at least in part on the measurements.

Aspect 20: The method of any of aspects 1 through 19, wherein the one or more constraints further comprise a transmit power constraint, wherein communicating the one or more sidelink messages comprises: transmitting the one or more sidelink messages via a plurality of carriers of the unlicensed wireless communications channel using a transmit power that satisfies the transmit power constraint.

Aspect 21: The method of any of aspects 1 through 20, wherein the one or more constraints further comprise a transmit power constraint associated with communications transmitted via the wireless communications channel over a time interval, the one or more sidelink messages are multiplexed via time-division multiplexing configuration with additional communications performed by a plurality of additional wireless communications devices throughout the time interval, a transmit power used to communicate the one or more sidelink messages is based at least in part on the transmit power constraint and the time-division multiplexing configuration.

Aspect 22: A UE comprising one or more memories storing processor-executable code, and one or more processors coupled with the one or more memories and individually or collectively operable to execute the code to cause the UE to perform a method of any of aspects 1 through 21.

Aspect 23: A UE comprising at least one means for performing a method of any of aspects 1 through 21.

Aspect 24: A non-transitory computer-readable medium storing code the code comprising instructions executable by one or more processors to perform a method of any of aspects 1 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
establish a wireless connection with a wireless communications device via an unlicensed wireless communications channel;
transmit control signaling to the wireless communications device, the control signaling comprising a communications configuration that indicates one or more constraints for communicating within the unlicensed wireless communications channel, the one or more constraints comprising a minimum bandwidth of the unlicensed wireless communications channel, a Fourier transform constraint, a subcarrier spacing constraint, or any combination thereof; and
communicate one or more sidelink messages with the wireless communications device via the unlicensed wireless communications channel using a set of communications parameters determined based at least in part on the communications configuration, wherein the set of communications parameters comprise a component carrier bandwidth, a fast Fourier transform size, and a subcarrier spacing.

2. The UE of claim 1, wherein the one or more processors are individually or collectively further operable to execute the code to cause the UE to:
receive, from a network entity, radio resource control signaling indicating a subcarrier spacing numerology associated with one or more subcarrier spacings for communicating with the network entity; and
communicate one or more messages with the network entity in accordance with the one or more subcarrier spacings associated with the subcarrier spacing numerology, wherein the subcarrier spacing constraint associated with communications over the unlicensed wireless communications channel comprises an expansion of the subcarrier spacing numerology to include one or more additional subcarrier spacings within the subcarrier spacing numerology, and wherein the subcarrier spacing used to communicate the one or more sidelink messages with the wireless communications device is different from the one or more subcarrier spacings based at least in part on the expansion of the subcarrier spacing numerology.

3. The UE of claim 1,
wherein the minimum bandwidth comprises a 500 MHz minimum bandwidth constraint, the Fourier transform constraint comprises an 8 k fast Fourier transform size constraint, and the subcarrier spacing constraint comprises an expansion of a subcarrier spacing numerology to include one or more additional subcarrier spacings, and
wherein the component carrier bandwidth comprises 500 MHz, the fast Fourier transform size comprises 8192, and the subcarrier spacing comprises 62.5 kHz.

4. The UE of claim 1,
wherein the minimum bandwidth comprises a 500 MHz minimum bandwidth constraint, the Fourier transform constraint comprises an 4 k fast Fourier transform size constraint, and the subcarrier spacing constraint comprises an expansion of a subcarrier spacing numerology to include one or more additional subcarrier spacings, and
wherein the component carrier bandwidth comprises 500 MHz, the fast Fourier transform size comprises 4096, and the subcarrier spacing comprises 125 kHz.

5. The UE of claim 1,
wherein the minimum bandwidth comprises a 500 MHz minimum bandwidth constraint, the Fourier transform constraint comprises an 8 k fast Fourier transform size constraint, and the subcarrier spacing constraint comprises an expansion of a subcarrier spacing numerology to include one or more additional subcarrier spacings, and
wherein the component carrier bandwidth comprises 1000 MHz, the fast Fourier transform size comprises 8192, and the subcarrier spacing comprises 125 kHz.

6. The UE of claim 1,
wherein the minimum bandwidth comprises a 500 MHz bandwidth constraint, the Fourier transform constraint comprises an 8 k fast Fourier transform size constraint, and the subcarrier spacing constraint comprises a subcarrier spacing of 60 kHz or 120 kHz, and
wherein the component carrier bandwidth comprises 983 MHz, the fast Fourier transform size comprises 8192, and the subcarrier spacing comprises 120 KHz.

7. The UE of claim 6, wherein the Fourier transform constraint further comprises a radix 2 or radix 4 fast Fourier transform constraint.

8. The UE of claim 1, wherein the one or more processors are individually or collectively further operable to execute the code to cause the UE to:
communicate one or more messages with a network entity in accordance with one or more radix fast Fourier transform sizes, wherein the Fourier transform constraint comprises a composite radix size constraint, and wherein the fast Fourier transform size for communicating the one or more sidelink messages with the wireless communications device is different from the one or more radix fast Fourier transform sizes based at least in part on the composite radix size constraint.

9. The UE of claim 8, wherein the one or more radix fast Fourier transform sizes comprise Radix 2, Radix 3, Radix 5, or any combination thereof, and wherein the fast Fourier transform size for communicating the one or more sidelink messages with the wireless communications device is determined based at least in part on the composite radix size constraint and in accordance with a Cooley Tukey algorithm, or a prime factor algorithm, or both.

10. The UE of claim 1,
wherein the minimum bandwidth comprises a 500 MHz minimum bandwidth constraint, the Fourier transform constraint comprises an 8 k fast Fourier transform size constraint and a composite radix size constraint, and the subcarrier spacing constraint comprises a preservation of subcarrier spacing numerology, and
wherein the component carrier bandwidth comprises 500 MHz, the fast Fourier transform size comprises 8640, and the subcarrier spacing comprises 60 KHz.

11. The UE of claim 1,
wherein the minimum bandwidth comprises a 500 MHz minimum bandwidth constraint, the Fourier transform constraint comprises an 8 k fast Fourier transform size constraint and a composite radix size constraint, and the subcarrier spacing constraint comprises a preservation of a subcarrier spacing numerology to maintain a minimum quantity of usable subcarrier spacings within the subcarrier spacing numerology, and
wherein the component carrier bandwidth comprises 500 MHz, the fast Fourier transform size comprises 4320, and the subcarrier spacing comprises 120 KHz.

12. The UE of claim 1,
wherein the minimum bandwidth comprises a 500 MHz minimum bandwidth constraint, the Fourier transform constraint comprises an 8 k fast Fourier transform size constraint and a composite radix size constraint, and the subcarrier spacing constraint comprises a preservation of a subcarrier spacing numerology to maintain a minimum quantity of usable subcarrier spacings within the subcarrier spacing numerology, and
wherein the component carrier bandwidth comprises 1000 MHz, the fast Fourier transform size comprises 8640, and the subcarrier spacing comprises 120 KHz.

13. The UE of claim 1,
wherein the minimum bandwidth comprises a relaxation of a 500 MHz minimum bandwidth constraint, the Fourier transform constraint comprises an 8 k fast Fourier transform size constraint, and the subcarrier spacing constraint comprises a preservation of a subcarrier spacing numerology to maintain a minimum quantity of usable subcarrier spacings within the subcarrier spacing numerology, and
wherein the component carrier bandwidth comprises 491 MHz, the fast Fourier transform size comprises 8192, and the subcarrier spacing comprises 60 KHz.

14. The UE of claim 1,
wherein the minimum bandwidth comprises a relaxation of a 500 MHz minimum bandwidth constraint, the Fourier transform constraint comprises an 8 k fast Fourier transform size constraint, and the subcarrier spacing constraint comprises a preservation of a subcarrier spacing numerology to maintain a minimum quantity of usable subcarrier spacings within the subcarrier spacing numerology, and
wherein the component carrier bandwidth comprises 491 MHz, the fast Fourier transform size comprises 4096, and the subcarrier spacing comprises 120 KHz.

15. The UE of claim 1,
wherein the minimum bandwidth comprises a relaxation of a 1000 MHz minimum bandwidth constraint, the Fourier transform constraint comprises an 8 k fast Fourier transform size constraint, and the subcarrier spacing constraint comprises a preservation of a subcarrier spacing numerology to maintain a minimum quantity of usable subcarrier spacings within the subcarrier spacing numerology, and
wherein the component carrier bandwidth comprises 983 MHz, the fast Fourier transform size comprises 8192, and the subcarrier spacing comprises 120 KHz.

16. The UE of claim 1, wherein the one or more processors are individually or collectively further operable to execute the code to cause the UE to:
perform measurements for the unlicensed wireless communications channel; and
identify, based at least in part on the measurements, a plurality of wireless communications devices including the wireless communications device that are to perform wireless communications multiplexed via the unlicensed wireless communications channel, wherein the one or more sidelink messages communicated with the wireless communications device are multiplexed with additional sidelink messages communicated with the plurality of wireless communications devices in accordance with a frequency-domain multiplexing pattern, a time-domain multiplexing pattern, or both, based at least in part on a quantity of wireless communications devices included within the plurality of wireless communications devices, an emission regulation, or both.

17. The UE of claim 16, wherein a transmit power used to communicate the one or more sidelink messages is based at least in part on the emission regulation and whether the one or more sidelink messages are communicated in accordance with the frequency-domain multiplexing pattern, the time-domain multiplexing pattern, or both.

18. The UE of claim 1, wherein the one or more processors are individually or collectively further operable to execute the code to cause the UE to:
receive, from a network entity, radio resource control signaling indicating the one or more constraints for communicating within the unlicensed wireless communications channel, wherein transmitting the control signaling, communicating the one or more sidelink messages, or both, is based at least in part on receiving the radio resource control signaling.

19. The UE of claim 1, wherein the one or more processors are individually or collectively further operable to execute the code to cause the UE to:
perform measurements for communications performed with the wireless communications device via the unlicensed wireless communications channel based at least in part on establishing the wireless channel with the wireless communications device, wherein the set of communications parameters are determined based at least in part on the measurements.

20. The UE of claim 1, wherein, to communicate the one or more sidelink messages, the one or more processors are individually or collectively operable to execute the code to cause the UE to:
transmit the one or more sidelink messages via a plurality of carriers of the unlicensed wireless communications channel using a transmit power that satisfies a transmit power constraint.

21. The UE of claim 1, wherein the one or more constraints further comprise a transmit power constraint associated with communications transmitted via the unlicensed wireless communications channel over a time interval, wherein the one or more sidelink messages are multiplexed via time-division multiplexing configuration with additional communications performed by a plurality of additional wireless communications devices throughout the time interval, and wherein a transmit power used to communicate the one or more sidelink messages is based at least in part on the transmit power constraint and the time-division multiplexing configuration.

22. A method for wireless communications at a user equipment (UE), comprising:
establishing a wireless connection with a wireless communications device via an unlicensed wireless communications channel;
transmitting control signaling to the wireless communications device, the control signaling comprising a communications configuration that indicates one or more constraints for communicating within the unlicensed wireless communications channel, the one or more constraints comprising a minimum bandwidth of the unlicensed wireless communications channel, a Fourier transform constraint, a subcarrier spacing constraint, or any combination thereof; and
communicating one or more sidelink messages with the wireless communications device via the unlicensed wireless communications channel using a set of communications parameters determined based at least in part on the communications configuration, wherein the set of communications parameters comprise a component carrier bandwidth, a fast Fourier transform size, and a subcarrier spacing.

23. The method of claim 22, further comprising:
receiving, from a network entity, radio resource control signaling indicating a subcarrier spacing numerology associated with one or more subcarrier spacings for communicating with the network entity; and
communicating one or more messages with the network entity in accordance with the one or more subcarrier spacings associated with the subcarrier spacing numerology, wherein the subcarrier spacing constraint associated with communications over the unlicensed wireless communications channel comprises an expansion of the subcarrier spacing numerology to include one or more additional subcarrier spacings within the subcarrier spacing numerology, and wherein the subcarrier spacing used to communicate the one or more sidelink messages with the wireless communications device is different from the one or more subcarrier spacings based at least in part on the expansion of the subcarrier spacing numerology.

24. The method of claim 22,
wherein the minimum bandwidth comprises a 500 MHz minimum bandwidth constraint, the Fourier transform constraint comprises an 8 k fast Fourier transform size constraint, and the subcarrier spacing constraint comprises an expansion of a subcarrier spacing numerology to include one or more additional subcarrier spacings, and
wherein the component carrier bandwidth comprises 500 MHz, the fast Fourier transform size comprises 8192, and the subcarrier spacing comprises 62.5 kHz.

25. The method of claim 22,
wherein the minimum bandwidth comprises a 500 MHz minimum bandwidth constraint, the Fourier transform constraint comprises an 4 k fast Fourier transform size constraint, and the subcarrier spacing constraint comprises an expansion of a subcarrier spacing numerology to include one or more additional subcarrier spacings, and
wherein the component carrier bandwidth comprises 500 MHz, the fast Fourier transform size comprises 4096, and the subcarrier spacing comprises 125 kHz.

26. The method of claim 22,
wherein the minimum bandwidth comprises a 500 MHz minimum bandwidth constraint, the Fourier transform constraint comprises an 8 k fast Fourier transform size constraint, and the subcarrier spacing constraint comprises an expansion of a subcarrier spacing numerology to include one or more additional subcarrier spacings, and
wherein the component carrier bandwidth comprises 1000 MHz, the fast Fourier transform size comprises 8192, and the subcarrier spacing comprises 125 kHz.

27. The method of claim 22,
wherein the minimum bandwidth comprises a 500 MHz bandwidth constraint, the Fourier transform constraint comprises an 8 k fast Fourier transform size constraint, and the subcarrier spacing constraint comprises a subcarrier spacing of 60 kHz or 120 kHz, and
wherein the component carrier bandwidth comprises 983 MHz, the fast Fourier transform size comprises 8192, and the subcarrier spacing comprises 120 KHz.

28. The method of claim 27, wherein the Fourier transform constraint further comprises a radix 2 or radix 4 fast Fourier transform constraint.

29. A non-transitory computer-readable medium storing code, the code comprising instructions executable by one or more processors to:
establish a wireless connection with a wireless communications device via an unlicensed wireless communications channel;
transmit control signaling to the wireless communications device, the control signaling comprising a communications configuration that indicates one or more constraints for communicating within the unlicensed wireless communications channel, the one or more constraints comprising a minimum bandwidth of the unlicensed wireless communications channel, a Fourier transform constraint, a subcarrier spacing constraint, or any combination thereof; and
communicate one or more sidelink messages with the wireless communications device via the unlicensed wireless communications channel using a set of communications parameters determined based at least in part on the communications configuration, wherein the set of communications parameters comprise a component carrier bandwidth, a fast Fourier transform size, and a subcarrier spacing.

30. A user equipment (UE), comprising:
means for establishing a wireless connection with a wireless communications device via an unlicensed wireless communications channel;
means for transmitting control signaling to the wireless communications device, the control signaling comprising a communications configuration that indicates one or more constraints for communicating within the unlicensed wireless communications channel, the one or more constraints comprising a minimum bandwidth of the unlicensed wireless communications channel, a Fourier transform constraint, a subcarrier spacing constraint, or any combination thereof; and
means for communicating one or more sidelink messages with the wireless communications device via the unlicensed wireless communications channel using a set of communications parameters determined based at least in part on the communications configuration, wherein the set of communications parameters comprise a component carrier bandwidth, a fast Fourier transform size, and a subcarrier spacing.
